(19) United States
(12) Patent Application Publication
(10) Pub. No.: US 2014/0077138 A1
(43) Pub. Date: Mar. 20, 2014

(54) BORON NITRIDE-BASED FLUID COMPOSITIONS AND METHODS OF MAKING THE SAME

(71) Applicants: Jose Jaime Taha-Tijerina, Nuevo Leon (MX); Narayanan Tharangattu Narayanan, Houston, TX (US); Pulickel Madhavapanicker Ajayan, Houston, TX (US); Daniel Paul Hashim, Deer Park, NY (US)

(72) Inventors: Jose Jaime Taha-Tijerina, Nuevo Leon (MX); Narayanan Tharangattu Narayanan, Houston, TX (US); Pulickel Madhavapanicker Ajayan, Houston, TX (US); Daniel Paul Hashim, Deer Park, NY (US)

(73) Assignee: William Marsh Rice University, Houston, TX (US)

(21) Appl. No.: 14/022,695

(22) Filed: Sep. 10, 2013

Related U.S. Application Data
(60) Provisional application No. 61/698,938, filed on Sep. 10, 2012.

(51) Int. Cl. H01B 3/12

(52) U.S. Cl. CPC H01B 3/12
USPC 252/572

(57) ABSTRACT

In some embodiments, the present invention pertains to fluid compositions that generally comprise: (1) a base fluid; and (2) boron nitride-based materials dispersed in the base fluid. In some embodiments, the boron nitride-based materials may include hexagonal boron nitride. In some embodiments, the boron nitride-based materials in the fluid compositions may be less than about 1% of the weight of the fluid composition. Additional embodiments of the present invention pertain to methods of making fluid compositions. Such methods generally include dispersing boron nitride-based materials in a base fluid, such as by mixing. In some embodiments, the methods of the present invention may also include steps of exfoliating or sonicating the bulk boron nitride-based materials followed by centrifugation and drying procedures.

### CROSS-REFERENCE TO RELATED APPLICATIONS

This application claims priority to U.S. Provisional Patent Application No. 61/698,938, filed on Sep. 10, 2012. The entirety of the aforementioned application is incorporated herein by reference.

### BACKGROUND

Insulating fluids find applications in many fields. However, such fluids suffer from various limitations, including limited thermal conductivity and electrical insulation. Furthermore, many insulating fluids require the use of high amounts of additives or surfactants that may in turn interfere with the physical properties of the fluids and the overall cost effectiveness. Thus, a need exists for improved insulating fluids that address the aforementioned limitations.

### BRIEF SUMMARY

In some embodiments, the present disclosure pertains to fluid compositions that generally comprise: (1) a base fluid; and (2) boron nitride-based materials dispersed in the base fluid. In some embodiments, the boron nitride-based materials may include, without limitation, exfoliated boron nitride, hexagonal boron nitride, cubic boron nitride, crystalline boron nitride, boron nitride sheets, boron nitride fibers, boron nitride nanotubes, boron nitride nanomesh, boron nitride nanoparticles, and combinations thereof.

In some embodiments, the boron nitride-based materials may include two-dimensional (2D) hexagonal boron nitride, such as hexagonal boron nitride in the form of atomically thick sheets (i.e., hexagonal boron nitride sheets). In various embodiments, the hexagonal boron nitride sheets contain from 2 atomic layers to 10 atomic layers, from 2 atomic layers to 6 atomic layers, or from 4 atomic layers to 5 atomic layers. In various embodiments, the hexagonal boron nitride sheets have dimensions that range from about 10 nm to about 10 μm on each side, from about 10 nm to about 1000 nm on each side, from about 100 nm to about 1000 nm on each side, or from about 100 nm to about 500 nm on each side. In some embodiments, the hexagonal boron nitride sheets have an aspect ratio of between about 1:1 and about 100:1, or from about 1:1 and about 10:1.

In some embodiments, the boron nitride-based materials in the fluid compositions of the present disclosure may be less than about 5% of the weight of the fluid composition. In some embodiments, the boron nitride-based materials in the fluid compositions may be from about 0.01% to about 0.1% of the weight of the fluid composition.

In some embodiments, the base fluid in the fluid compositions may include, without limitation, mineral oils, naphthenic oils, vegetable oils, synthetic oils, bio-based oils, natural and synthetic esters, crude oils, silicon fluids, silicate fluids, petroleum grease, silicone grease, water, brine, seawater, kerosene, ethylene glycols, aqueous fluids, non-aqueous fluids, oil-water emulsions, ionic liquids, clay-based fluids, thixotropic clay-based fluids, bentonite-based fluids, molten salt-based fluids, lubricants, metal-cutting fluids, and combinations thereof. In some embodiments, the base fluid may include mineral oils.

In some embodiments, the fluid compositions of the present disclosure further comprise a dispersing agent. In some embodiments, the dispersing agent comprises about 5% by weight of the fluid composition. In some embodiments, the dispersing agent comprises less than about 5% by weight of the fluid composition.

Additional embodiments of the present disclosure pertain to methods of making fluid compositions. Such methods generally include dispersing boron nitride-based materials in a base fluid, such as by mixing. In some embodiments, the methods of the present disclosure may also include steps of exfoliating or sonicating the boron nitride-based materials.

The fluid compositions of the present disclosure provide various advantages, including enhanced thermal conductivity at very low concentrations of boron nitride-based materials with retained electrical insulation. For instance, in some embodiments, the fluid compositions of the present disclosure may have an enhanced thermal conductivity of about 5% to about 80% relative to the base fluid. In some embodiments, the fluid compositions of the present disclosure may have a reduced coefficient of friction (COF) of about 5% to about 30% relative to the base fluid. In some embodiments, the fluid compositions of the present disclosure may obtain such properties without the use of any dispersing agents, such as surfactants.

### BRIEF DESCRIPTION OF THE FIGURES

FIG. 1 provides a graph illustrating enhanced thermal conductivity in mineral oils containing hexagonal boron nitride (h-BN), at low filler fraction (0.10 wt. %) compared to pure mineral oil.

FIG. 2 illustrates the production method for exfoliation of h-BN. FIG. 2A provides a schematic of liquid exfoliation of h-BN crystals in to 2D h-BN nanosheets using sonication and centrifugation. Organic solvents (e.g. Isopropanol (IPA) or Dimethylformamide (DMF)) (green spheres in figure) are used for liquid exfoliation. FIG. 2B shows a transmission electron microscopy (TEM) image of h-BN. The corresponding selected area electron diffraction (SAED) pattern is shown in inset showing few layered sheets. The SAED pattern shows the crystallinity of the exfoliated nanosheets with adjacent nanosheets having rotational disorder. FIG. 2C shows the x-ray diffraction (XRD) pattern of dried h-BN nanosheet powders. FIG. 2D shows micro-Raman spectrum (633 nm excitation) of h-BN nanosheets depicting the E2g mode of B-N vibrations in h-BN nanosheets.

FIG. 3 shows photographs of pure mineral oil (MO) and various suspensions of h-BN/MO and graphene/MO in a white background. The right panel shows a schematic of 2D layers (h-BN/graphene) in MO stabilized via Brownian motion and interactions with MO.

FIG. 4 shows data indicating enhanced thermal conductivity in MO with h-BN. FIG. 4A shows temperature-dependent effective thermal conductivity (TC) enhancement of various nanofluids (percentage of filler amount is mentioned). Pure MO shows no variation in TC with temperature. All nanofluids show an enhancement in thermal conductivity with temperature, indicating the contribution of Brownian motion in thermal conductivity enhancement. FIG. 4B shows enhancement in thermal conductivity with increase in the h-BN concentration in MO measured at 323 K. This indicates the formation of percolation channels for thermal conduction by high surface area h-BN flakes, as explained by network model (inset shows the variation in TC between 0.01 and 0.05 wt. %). The error bars attached to the results incorporate the variation in the different measurements. FIG. 4C shows temperature-dependent dissipation factor variation of various nanofluids. h-BN/MO shows the lowest DF, indicating their enhanced dielectric nature. FIG. 4D shows electrical resistivity variation of nanofluids. h-BN/MO shows the highest electrical resistivity, while graphene/MO shows the lowest electrical resistance in comparison to pure MO.

FIG. 5 shows data relating to viscosity and pour point variations in MO with h-BN. FIG. 5A shows temperature-dependent viscosity variation of nanofluids (black crosses (X) indicate theoretical values calculated using the theory of Hinch and Leal, and colored points indicate the experimental values). Small deviations from the theoretical values of viscosity at higher concentrations of h-BN/MO may be a result of a transition from a dilute to a semi-dilute phase or due to the onset of some small aggregation between the h-BN nanosheets. FIG. 5B shows pour point variation of various fluids. The lowering of the pour point of h-BN/MO indicates the possible molecular interactions between h-BN and MO.

FIG. 6 provides additional TEM images of h-BN. FIGS. 6A-6B show regular TEM images of h-BN. FIG. 6C shows a high resolution (HR)-TEM image of h-BN. The HRTEM shows that the number of layers is around 5.

FIG. 7 shows TEM images of graphene. FIG. 7A shows a TEM and an SAED at the inset. FIG. 7B shows an HR-TEM of graphene. The HRTEM shows the number of layers to be around 10.

FIG. 8 shows an XRD (left) and a micro-Raman spectrum (@633 nm excitation) (right) of graphene. The pristine graphite consists of sharp XRD reflection peaks indicating the presence of many numbers of graphitic layers. In the case of exfoliated graphite (G), the reflection peaks are broadened (black). However, G consists of few layers of ordered graphene sheets. The number of layers can be calculated from the Lorentzian curve fitting of (002) reflection peak (the 100% peak) and Debye-Scherrer formula. In the present case, Applicants found that G consists of 10-12 layers, which is in agreement with the TEM observations.

FIG. 9 shows a photograph (in dark ground) of MO and h-BN/MO (0.01 wt. % and 0.10 wt. %). The photographs show the transparency of the nanofluids.

FIG. 10 shows a comparison of thermal conductivity enhancement of 0.01 wt. % h-BN/MO and graphene/MO. Graphene/MO shows a little enhancement (˜1%) in TC compared to h-BN/MO.

FIG. 11 shows two possible orientations of a sensor probe used for measuring nanofluid thermal conductivity. The arrow mark indicates the flow of the nanofluid.

FIG. 12 provides a chart summarizing the development of various oil-based nanofluids for thermal management.

FIG. 13 provides a table of material properties used to study the tribology performance (coefficient of friction and wear studies) of boron nitride-based fluid compositions according to two different testing methods: ITEePib Polish and ASTM D5183.

FIG. 14 shows a schematic of the Tribotester T-02 testing device that is used for the ASTM D5183 and ITEePib Polish test methods. The device components include ball chuck 1, rotating ball 2, stationary balls 3, and ball pot 4.

FIG. 15 shows a typical chart for scuffing initiation phenomenon. This chart is an example to help identify the extreme pressure properties of the nanofluids, namely the load behavior, P, and friction torque, Mₜ, over time as a film lubricant disappears and the wear begins. The “seizure” point appears when the film lubricant disappears and the balls have a metal-metal contact. Meanwhile, the p_{oz} represents the seizure load.

FIG. 16 shows a table of the testing parameters using the T-02 tribotester.

FIG. 17 is a plot of the temperature-dependent effective thermal conductivity (TC) of the h-BN and Graphene (G) nanofluids using Eco Draw® as a base fluid (percentage of filler amount is mentioned). Pure base fluids show no significant variation in TC with temperature. All nanofluids show an enhancement in TC with temperature, indicating the contribution of Brownian motion and percolation mechanism in TC enhancement.

FIG. 18 is a plot of the temperature-dependent effective thermal conductivity (TC) of the h-BN and Graphene (G) nanofluids using Montgomery® as a base fluid (percentage of filler amount is mentioned). Pure base fluids show no significant variation in TC with temperature. All nanofluids show an enhancement in TC with temperature, indicating the contribution of Brownian motion and percolation mechanism in TC enhancement.

FIG. 19 is a plot of the temperature-dependent effective thermal conductivity (TC) of the h-BN and Graphene (G) nanofluids using Metkut® as a base fluid (percentage of filler amount is mentioned). Pure base fluids show no significant variation in TC with temperature. All nanofluids show an enhancement in TC with temperature, indicating the contribution of Brownian motion and percolation mechanism in TC enhancement.

FIG. 20 is a plot of the temperature-dependent effective thermal conductivity (TC) of the h-BN and Graphene (G) nanofluids using Metkool® as a base fluid (percentage of filler amount is mentioned). Pure base fluids show no significant variation in TC with temperature. All nanofluids show an enhancement in TC with temperature, indicating the contribution of Brownian motion and percolation mechanism in TC enhancement.

FIG. 21 is a plot of the temperature-dependent viscosity variation of the h-BN and Graphene (G) nanofluids using Eco Draw® as a base fluid showing negligible increments with increased filler fraction.

FIG. 22 is a plot of the temperature-dependent viscosity variation of the h-BN and Graphene (G) nanofluids using Montgomery® as a base fluid showing negligible increments with increased filler fraction.

FIG. 23 is a plot of the temperature-dependent viscosity variation of the h-BN and Graphene (G) nanofluids using Metkool® as a base fluid showing negligible increments with increased filler fraction.

FIG. 24 is a plot of the temperature-dependent viscosity variation of the h-BN and Graphene (G) nanofluids using Metkut® as a base fluid showing negligible increments with increased filler fraction.

FIG. 25 is a plot of the coefficient of friction (COF) percent decrease of the nanofluids compared to the mineral oil (MO) base fluid. MO was enhanced by 0.01 wt. % of h-BN and G, including 0.01 wt. % h-BN mixed with 2% oleic acid (OA) dispersing agent and measured using ASTM D5183 standard test.

FIG. 26 is a plot of the wear scar diameter percent decrease of the nanofluids compared to the mineral oil (MO) base fluid. MO was enhanced by 0.01 wt. % of h-BN and G, including 0.01 wt. % h-BN mixed with 2% oleic acid (OA) dispersing agent and measured using ASTM D5183 standard test.

FIG. 27 shows scanning electron microscopy (SEM) images of steel balls before tribo-testing (FIG. 27A) and after testing using MO/h-BN showing the wear scar (FIG. 27B). Also shown are h-BN flakes on wear scar (FIG. 27C) and MO/graphene (FIG. 27D).

FIG. 28 shows energy dispersive x-ray (EDAX) of the tested steel balls (top) for pure mineral oil (MO) and (bottom) for MO/h-BN, revealing the presence of both a boron signal and a nitrogen signal representing the h-BN sheets remaining on the surface.

FIG. 29 shows a table of the wear scar diameter (WSD) and coefficient of friction (COF) decreased for h-BN and G nanofluids obtained by the ASTM D5183 method.

FIG. 30 shows a table of the pressure loss limit (p_{oz}) results of the h-BN and G nanofluid films obtained from the ITEePib Polish method.

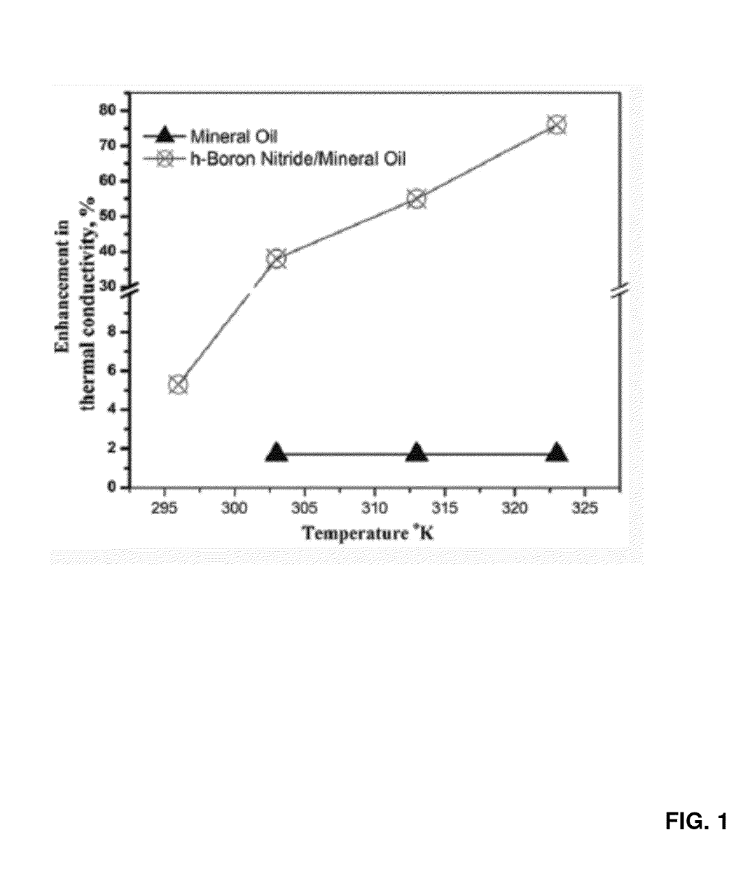

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Nanofluids generally refer to suspensions containing nanoparticles in a carrier or base fluid. Various materials have been identified to form good nanoparticle suspensions. Such materials have included metallic nanoparticles (such as Cu, Ag, Au, Ni, Fe, Co, Al, AlN, and carbon nanotubes) and non-metallic nanoparticles (such as nitrides, boron, Fe₃O₄, Al₂O₃, CuO, TiO₂, oxides, carbide ceramics, and SiC).

Nanofluid-based heat transfer plays an important role in diverse fields such as cooling systems, solar energy conversion systems, microelectronics, high voltage power transmission systems, automobiles, solar cells and photovoltaic cooling, oil and gas down hole drilling operations such as drilling “mud” fluids, biopharmaceuticals, medical therapy/diagnosis, military and space applications, and nuclear cooling. The miniaturization and high efficiency of electrical/electronic devices in these fields demand successful heat management and energy-efficient fluid-based heat-transfer systems. Furthermore, high thermal conductivity is desired for such heat-transfer fluids. However, conventional heat-transfer fluids such as water, ethylene glycol, and engine/transformer oils are typically low-efficiency heat-transfer fluids. In fact, solid materials have higher thermal conductivity than these conventional fluids. As such, the advent of nanofluids for heat transfer has provided better thermal conductivities for the aforementioned applications.

For instance, nanofluids containing metallic nanoparticles have shown significantly enhanced thermal properties in comparison to traditional cooling fluids. Thus, diverse investigations have been made on such nanoparticles in various base-fluids, such as water, deionized water, ethyl-glycol, kerosene, engine oil, mineral oil, vegetable oil, silicon fluid, and the like.

Nonetheless, heat transfer using fluids is a complex phenomenon. Various factors such as fluid stability, composition, viscosity, surface charge, interface, and morphology of the dispersed particles influence the observed results. Furthermore, the reported high thermal conductivity values of nanofluids are far from satisfactory for practical implementations. For instance, improvements in nanofluid thermal conductivity cannot be achieved by increasing the solid filler amount beyond a limit because an increase in filler concentration will increase the viscosity of the nanofluid, thereby adversely affecting the nanofluid's properties.

Hence, a need exists for new nanofillers that can attain high thermal conductivities for nanofluids at lower filler fractions. Moreover, a need exists for nanofillers that would provide increased thermal conductivities without increasing electrical conductivity or limiting particle dispersion (as in ceramic particles). The present disclosure addresses the aforementioned limitations.

In some embodiments, the present disclosure pertains to fluid compositions that include a base fluid and boron nitride-based materials dispersed in the base fluid. In more specific embodiments, the present disclosure pertains to fluid compositions comprising boron nitride-based materials and/or nanomaterials of a newly specified two-dimensional atomic layered sheet-like form as additives to base fluids. In various embodiments, combinations of specific dimensions and concentrations of boron nitride-based materials are described for obtaining advanced heat transfer, tribology, corrosion, and insulation properties of base fluids.

Additional embodiments of the present disclosure pertain to methods of making and using the aforementioned fluid compositions in various applications and products. Additional details about the embodiments of the present disclosure will be disclosed herein as non-limiting examples.

### Fluid Compositions

The fluid compositions of the present disclosure generally include: (1) a base fluid; and (2) boron nitride-based materials dispersed in the base fluid. The fluid compositions of the present disclosure may also be referred to as nanofluids. In some embodiments, the fluid compositions of the present disclosure may lack any dispersing agents, such as surfactants. In some embodiments, the fluid compositions of the present disclosure may be substantially free of any dispersing agents. In some embodiments, the fluid compositions of the present disclosure may include dispersing agents, such as surfactants.

In some embodiments, the fluid compositions of the present disclosure may be in the form of colloidal suspensions. In some embodiments, the fluid compositions may be aqueous. In some embodiments, the fluid compositions may be non-aqueous. As set forth in more detail herein, various boron nitride-based materials and base fluids may be used in the fluid compositions of the present disclosure.

Boron Nitride-Based Materials

In some embodiments, the boron nitride-based materials of the present disclosure may include, without limitation, boron nitride, exfoliated boron nitride (BN), hexagonal boron nitride (h-BN), cubic boron nitride, crystalline boron nitride, boron nitride sheets, boron nitride fibers, boron nitride nanotubes, boron nitride nanomesh, boron nitride nanoparticles, and combinations thereof.

In some embodiments, the fluid compositions of the present disclosure may include hexagonal boron nitride. In some embodiments, the hexagonal boron nitride may be in the form of sheets, such as two-dimensional (2-D) sheets.

By way of background, the advent of two-dimensional (2D) materials (having just few atoms in thickness) brought about a new class of materials to be explored for many applications. The pioneering 2D material was graphene, which may be derived by exfoliation of bulk graphite (an atomically layered structure by nature) into sheets as thin as one atomic layer of carbon atoms arranged in a hexagonal lattice. Another 2D material discovered (which received less attention than graphene) was hexagonal boron nitride (h-BN), a graphene-like structure where the carbon atoms are replaced with boron and nitrogen atoms in a 1:1 ratio. 2D forms of h-BN can also be achieved by similar exfoliation techniques performed on bulk h-BN crystals, which also happens to be an atomically layered structure by nature.

Various embodiments of the present disclosure pertain to fluid compositions (e.g., additives to heat transfer fluids and lubricants) that contain 2D forms of h-BN materials. In various embodiments, the 2D forms of h-BN materials have a 2D monoatomic planar structure with a specified number of layers or atoms in thickness.

In some embodiments, the hexagonal boron nitride sheets may include from 2 atomic layers to 10 atomic layers. In some embodiments, the hexagonal boron nitride sheets may include from 2 atomic layers to 6 atomic layers. In some embodiments, the hexagonal boron nitride sheets may include from 4 atomic layers to 5 atomic layers.

In some embodiments, the hexagonal boron nitride sheets may be anisotropic. In some embodiments, the hexagonal boron nitride sheets may be isotropic. In some embodiments, the hexagonal boron nitride sheets have dimensions that range from about 10 nm to about 10 μm on each side. In some embodiments, the hexagonal boron nitride sheets have dimensions that range from about 1 μm to about 10 μm on each side. In some embodiments, the hexagonal boron nitride sheets have dimensions that range from about 10 nm to about 1000 nm on each side. In some embodiments, the hexagonal boron nitride sheets have dimensions that range from about 100 nm to about 1000 nm on each side. In some embodiments, the hexagonal boron nitride sheets have dimensions that range from about 100 nm to about 500 nm on each side.

The hexagonal boron nitride sheets of the present disclosure can also have various aspect ratios. For instance, in some embodiments, the hexagonal boron nitride sheets of the present disclosure have an aspect ratio of between about 1:1 and about 100:1. In some embodiments, the hexagonal boron nitride sheets of the present disclosure have an aspect ratio of between about 1:1 and about 50:1. In some embodiments, the hexagonal boron nitride sheets of the present disclosure have an aspect ratio of between about 1:1 and about 10:1. In some embodiments, the hexagonal boron nitride sheets of the present disclosure have an aspect ratio of about 1:1.

The fluid compositions of the present disclosure may also contain various concentrations of boron nitride-based materials. In some embodiments, the boron nitride-based materials may include less than about 5% of the fluid composition. In some embodiments, the boron nitride-based materials may include less than about 1% of the weight of the fluid composition. In some embodiments, the boron nitride-based materials may include from about 0.01% to about 0.1% of the weight of the fluid composition. In some embodiments, the boron nitride-based materials may include from about 0.01% to about 0.05% of the weight of the fluid composition. In some embodiments, the boron nitride-based materials may include about 0.01% of the weight of the fluid composition. In some embodiments, the boron nitride-based materials may include about 0. 1% of the weight of the fluid composition.

Furthermore, the boron nitride-based materials of the present disclosure may include various geometries and sizes. The surface of the boron nitride-based materials may also be modified to tune the shelf life and transport properties of the fluid compositions.

Base Fluids

Various base fluids may also be utilized in the fluid compositions of the present disclosure. In some embodiments, the base fluid may include at least one of mineral oils, naphthenic oils, vegetable oils, synthetic oils, bio-based oils, natural and synthetic esters, crude oils, silicon fluids, silicate fluids, petroleum grease, silicone grease, water, brine, seawater, kerosene, ethylene glycols, aqueous fluids, non-aqueous fluids, oil-water emulsions, ionic liquids, clay-based fluids, thixotropic clay-based fluids (e.g., bentonite-based fluids), molten salt-based fluids, lubricants, metal-cutting fluids, and combinations thereof. In more specific embodiments, the base fluid may include mineral oils.

Additional base fluids in which boron nitride-based materials may be dispersed in can also be envisioned. Non-limiting examples of such base fluids are disclosed in International Pub. Nos. WO 2012/033975 A1 and WO 2013/028455 A1.

In some embodiments, the base fluids of the present disclosure may also include one or more solvents. In some embodiments, the solvents may include, without limitation, aromatic solvents, non-aromatic solvents, aqueous solvents, non-aqueous solvents, and combinations thereof. In some embodiments, the solvents may include, without limitation, alcohols, glycols, ketones, esters, ethers, chlorinated solvents, aromatic solvents, water, brine, and combinations thereof. Additional suitable solvents are disclosed in International Pub. Nos. WO 2012/033975 A1 and WO 2013/028455 A1.

Dispersing Agents

In some embodiments, the fluid compositions of the present disclosure further comprise a dispersing agent. In some embodiments, the dispersing agent may be used for enhanced suspension stability over time. In some embodiments, the dispersing agent may be used to prevent agglomeration or sedimentation.

In some embodiments, the dispersing agent may include a fatty acid. In some embodiments, the fatty acid may include, without limitation, myristoleic acid, palmitoleic acid, sapienic acid, oleic acid, elaidic acid, vaccenic acid, linoleic acid, linoelaidic acid, a-linolenic acid, arachidonic acid, eicosapentaenoic acid, erucic acid, docosahexaenoic acid, and combinations thereof. In some embodiments, the dispersing agent may include oleic acid.

In some embodiments, the dispersing agent is a surfactant. In some embodiments, the surfactant includes at least one of sodium dodecyl sulfate (SDS), cetyl triethyl ammonium bromide (CTAB), Triton X-100, Triton X-114, CHAPS, DOC, NP-40, and combinations thereof.

In some embodiments, the dispersing agent may be a polymer surfactant. In some embodiments, the polymer surfactant may include, without limitation, polyvinylpyrrolidone, polyethylene glycol, polypropylene glycol, polyacrylic acid, polyvinylacetate, polyvinylalcohol, and combinations thereof. Additional suitable surfactants that can be used as dispersing agents in the present disclosure are disclosed in International Pub. No. WO 2013/028455.

The fluid compositions of the present disclosure can have various concentrations of dispersing agents. In some embodiments, the dispersing agents may be present in concentrations of about 5% by weight or by volume of the fluid composition. In some embodiments, the dispersing agents may be present in concentrations of less than about 5% by weight or by volume of the fluid composition. In some embodiments, the dispersing agents may include about 5% by weight of the fluid composition. In some embodiments, the dispersing agents may include less than about 5% by weight of the fluid composition. In some embodiments, the dispersing agents may be present in concentrations of 5.0% or less, 3.5% or less, 2% or less, 2.5% or less, 1.5% or less, 0.5% or less, or 0.1% or less by weight of the fluid composition. In some embodiments, the dispersing agent is about 2% by weight of the fluid composition.

Methods of Making Fluid Compositions

Additional embodiments of the present disclosure pertain to methods of making the aforementioned fluid compositions. In some embodiments, such methods include dispersing one or more boron nitride-based materials in a base fluid. In some embodiments, the dispersion may occur by mixing at various temperatures, such as room temperature. In some embodiments, the dispersion may occur in a closed container or under vacuum to avoid any moisture absorption.

In some embodiments, methods of making boron nitride-based materials may include exfoliating the boron nitride-based materials in order to enhance their dispersion in base fluids. In some embodiments, the exfoliation of the boron nitride-based materials may occur by sonication. In various embodiments, the exfoliation of the boron nitride-based materials may occur before, during or after the dispersion of the boron-based materials in a base fluid.

In some embodiments, methods of making boron nitride-based materials may also include a step of centrifugation of the boron nitride-based materials. In some embodiments, the centrifugation may occur after the dispersion of the boron-based materials in a base fluid. In some embodiments, the centrifugation may occur after the exfoliation of the boron-based materials. In some embodiments, centrifugation speeds may include, without limitation, between about 1,000 rpms to about 10,000 rpms, between about 1,000 rpms to about 5,000 rpms, or between about 1,000 rpms to about 2,000 rpms. In some embodiments, centrifugation time may be from about 10 minutes to about 60 minutes. In some embodiments, centrifugation time may be about 30 minutes. In more specific embodiments, centrifugation occurs for about 30 minutes at a speed of about 1,500 rpm.

In more specific embodiments, various aqueous and non-aqueous nanofluids can be prepared through controlled dispersion of particles within a base fluid. For instance, various compositions of exfoliated h-BN nanosheets and exfoliated h-BN in powder-like form can be prepared by a simple room temperature mixing using mineral oil/vegetable oil as the base fluid. Thereafter, the obtained nanofluids can be sonicated for several hours (e.g., 3 hours).

Applications and Advantages

As set forth in more detail in the examples herein, the fluid compositions of the present disclosure provide numerous advantages. For instance, in some embodiments, the fluid compositions of the present disclosure may have enhanced thermal conductivities that range from about 5% to about 80% relative to the base fluid. In some embodiments, the thermal conductivity of the fluid composition may gradually increase with increasing concentrations of boron nitride-based materials. In some embodiments, the thermal conductivity ratio (Kₑ/K_{f}) (Kₑ=Thermal conductivity of the nanofluid, K_{f}=Thermal conductivity of the base fluid) of the fluid compositions may be about 1.8.

In some embodiments, the fluid compositions of the present disclosure may have a reduced coefficient of friction (COF) of about 5% to about 30% relative to the base fluid. In some embodiments, the fluid compositions of the present disclosure may have a reduced coefficient of friction (COF) of about 10% relative to the base fluid. In some embodiments, the fluid compositions of the present disclosure may have a reduced coefficient of friction (COF) of about 20% relative to the base fluid.

In fact, the fluid compositions of the present disclosure can combine higher thermal conductivity (keeping electrical insulation) than those of regular nanofluids reported in the literature. Furthermore, the fluid compositions of the present disclosure may possess optimal corrosion resistant properties, especially when h-BN is utilized as a boron nitride-based material.

In addition, the fluid compositions of the present disclosure may remain stable without the use of any dispersing agents (e.g., surfactants) or other additives. For instance, in some embodiments, fluid compositions with low amounts of boron nitride-based materials (e.g., 0.01-0.10 wt. %) may remain highly stable in base fluids (e.g., mineral oil) with a high shelf life (e.g., more than 3 months) without any surfactants.

As such, the fluid compositions of the present disclosure may have numerous variations and applications. In some embodiments, the fluid compositions of the present disclosure may provide novel colloidal materials based on boron nitride particles and exfoliated boron nitride sheets that could be utilized for the preparation of novel thermal management materials. In more specific embodiments, the fluid compositions of the present disclosure may be used as electrically insulating colloidal boron nitride suspensions with various base fluids, such as mineral oil, vegetable oil, silicon fluid, lubricants and metal-cutting fluids, and other similar carrier fluids.

In some embodiments, the fluid compositions of the present disclosure may have wide applications in thermal management, corrosion resistance, and electrical insulation. In some embodiments, the fluid compositions of the present disclosure may find applications in tribology fields, such as electrical machines (e.g., electrical transformers, motors and engines), metal-mechanic fields (e.g. lubricants and metal-cutting fluids), oil and gas fields (e.g. drilling, extraction process) and the electronic circuit industry. More specific applications for the fluid compositions of the present disclosure are disclosed herein.

Applications for Electrical Transformers and Electrical Motors/Engines

Thermal management is an important problem and challenge that the present disclosure can address. For instance, the fluid compositions of the present disclosure can have direct applications in the thermal performance of insulating nanofluids within electrical devices, components, and electrical transformers. Furthermore, the fluid compositions of the present disclosure can be used to dielectrically insulate the internal components of electrical devices. This in turn can reduce component size, thereby reducing costs.

Applications for Downhole Drilling Fluid Additives for the Oil & Gas Industry

In some embodiments, the fluid compositions of the present disclosure can have applications as additives to downhole drilling fluids. In some embodiments, the drilling fluids containing the fluid compositions of the present disclosure can be used in wellbore imaging, logging while drilling (LWD), monitoring while drilling (MWD), and the like.

Applications as Coolants and Lubrication fluids

In some embodiments, the fluid compositions of the present disclosure can have applications as coolants and/or lubrication fluids for various operations in the automobile industry. For instance, in some embodiments, the fluid compositions of the present disclosure can be used in rubber drilling/machining operations in the automobile tire industry.

In particular, the automobile tire industry may require water-based lubricants as opposed to oil-based drilling lubricants, which may damage the rubber products. In some embodiments, h-BN nanosheets in the fluid compositions of the present disclosure are water-stable and dispersible additives to the water-based fluids. The enhanced thermal conductivity of the fluid compositions would allow for faster drilling speeds, thereby allowing more production and prevention of thermal degradation to the rubbers. The enhanced thermal conductivity of the fluid compositions of the present disclosure would also simultaneously decrease the friction heat loss and torque required of the drilling process to allow for significant energy savings.

Applications for Concentrated Solar Power (CSP) Plants

In some embodiments, the fluid compositions of the present disclosure may also serve as additives to the base heat transfer fluids (HTFs) used in concentrated solar power (CSP) plants, including molten salt-based fluids. In some embodiments, the higher thermal conductivity can speed the heat transfer rate and allow for a smaller CSP plant design.

Transmission Fluids

In some embodiments, the fluid compositions of the present disclosure can be utilized as components of transmission fluids. For instance, by utilizing the advanced heat transfer and tribology properties of the fluid compositions of the present disclosure (e.g., h-BN containing fluids), the fluid compositions of the present disclosure may offer less wear and tear on the engine gears. The fluid compositions of the present disclosure may also prolong the engine life-time or allow more extreme conditions for more advanced engine designs.

Heat Exchangers

In some embodiments, the fluid compositions of the present disclosure can be used as components of heat exchangers. For instance, the higher thermal conductivities of the fluid compositions of the present disclosure may increase the heat transfer efficiency, thereby allowing a reduction in heat exchanger sizes. This may in turn reduce heat exchanger costs.

Dielectrical Insulation

The fluid compositions of the present disclosure may also be used for electrical insulation. For instance, boron nitride possesses optimal electrical insulation. Thus, when added to base fluids, the dielectric properties of the fluid composition can be enhanced. Such properties could in turn provide an advantage in design and engineering, such as the design and engineering of shorter component interaction distances in electrical transformers or motors.

Corrosion Resistance

The fluid compositions of the present disclosure may also possess optimal corrosion resistant properties. Hence, in some embodiments, nanofluids containing h-BN can maintain this property, thereby enhancing component performance and lifetime.

Tribology Applications

Lubrication and wear resistance are desirable for many engine components and mechanisms. Due to their optimal thermal performance, the fluid compositions of the present disclosure can perform with better wear behavior in many of these components. Furthermore, the fluid compositions of the present disclosure can enhance thermal dissipation within various machines and apparatus, such as electrical transformers and motors. For instance, h-BN has the same order of thermal conductivity of graphite. In addition, h-BN is an optimal dielectric. As set forth in more detail herein, the observed thermal conductivity of h-BN nanofluids was around twice of the base fluid, even at low h-BN weight percentages. Thus, the fluid compositions of the present disclosure can have an impact in reducing energy consumption, reducing costs, and increasing product reliability.

### ADDITIONAL EMBODIMENTS

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1

### Development and Characterization of h-BN Containing Nanofluids

Example 1 herein pertains to electrically insulating thermal nano-oils that utilize 2D fillers. Different nanoscale fillers have been used to create composite fluids for applications such as thermal management. The ever increasing thermal loads in applications now require advanced operational fluids, for example, high thermal conductivity dielectric oils in transformers. These oils require optimal filler dispersion, high thermal conduction, but also electrical insulation. Such thermal oils that conform to this thermal/electrical requirement, and yet remain in highly suspended stable state, have not yet been synthesized. Applicants report herein the synthesis and characterization of stable high thermal conductivity Newtonian nanofluids using exfoliated layers of hexagonal boron nitride in oil without compromising its electrically insulating property. Two-dimensional nanosheets of hexagonal boron nitride are liquid exfoliated in isopropyl alcohol and re-dispersed in mineral oil, used as standard transformer oil, forming stable nanosuspensions with high shelf life. A high electrical resistivity, even higher than that of the base oil, is maintained for the nano-oil containing small weight fraction of the filer (0.01 wt. %), whereas the thermal conductivity was enhanced. The low dissipation factor and high pour point for this nano-oil suggests several applications in thermal management.

More specifically, Applicants report herein the synthesis and characterization of a novel nanofluid containing hexagonal boron nitride (h-BN) in mineral oil (MO; standard electrical insulating transformer oil). The properties of these fluids are also compared with its 2D carbon analogue, graphene (exfoliated graphite). Graphene fluids represent both thermally and electrically conducting fluids, finding applications like thermal management coupled with static charge dissipation in oil tanks and solar panel applications, while h-BN fluids represent thermally conducting and electrically insulating fluids.

Recent advances in layered materials enable large-scale synthesis of various two-dimensional (2D) materials. Two-dimensional materials can be good choices as nanofillers in heat-transfer fluids, due to the high surface area they have available for heat transfer. Among various 2D materials, hexagonal boron nitride or graphene exhibits versatile properties, such as optimal thermal conductivity, mechanical stability, and chemical inertness. As an insulating material with high thermal conductivity, hexagonal boron nitride (h-BN) surpasses other nanofillers. Thus, it is envisioned that h-BN is an optimal material for high thermal conductivity and electrically insulating composites. However, theoretical studies indicate that high thermal conductivities can only be achieved from the (002) planes of hexagonal boron nitride. Exfoliated hexagonal boron nitride (h-BN) can give maximum exposure to these (002) lattice planes.

### Example 1.1

### Liquid Exfoliation of h-BN Crystals

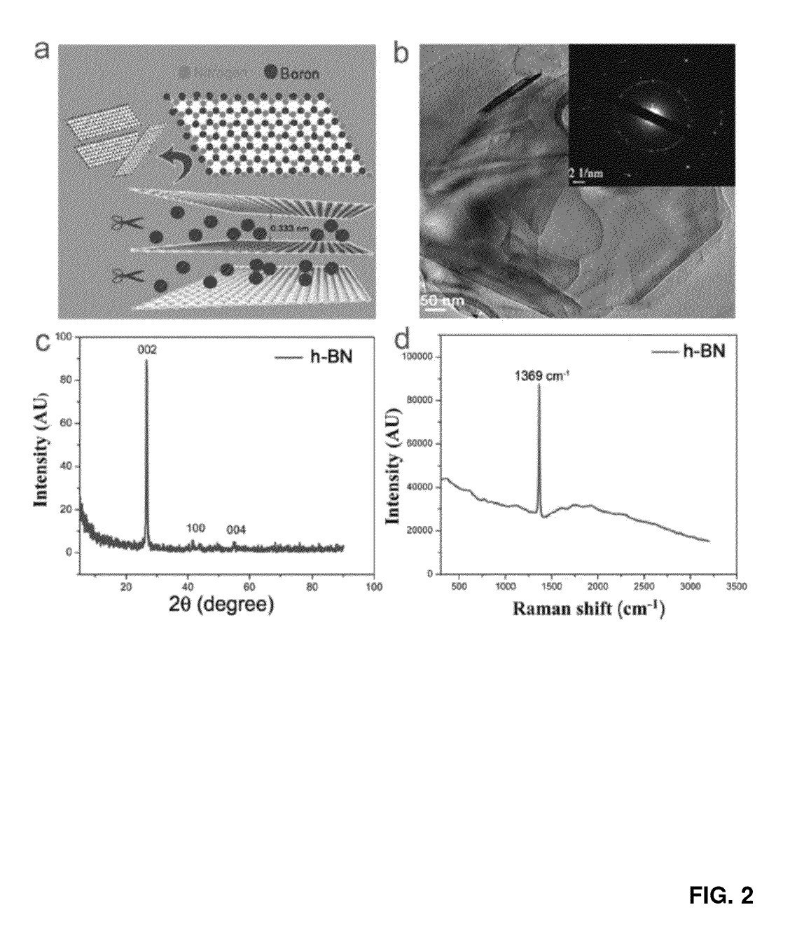

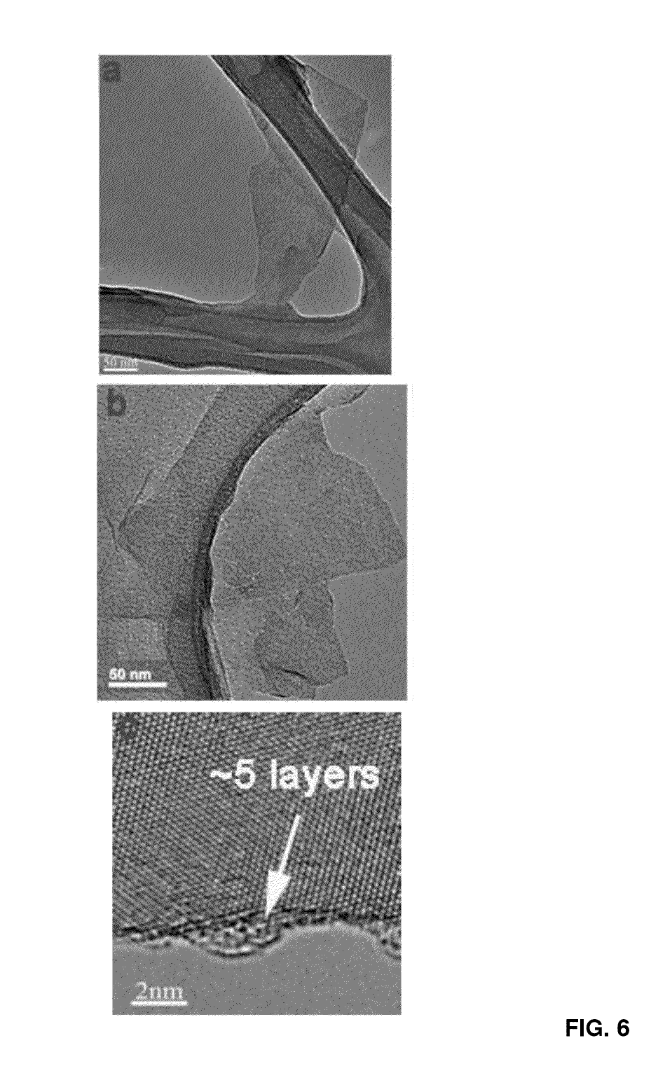

The schematic of liquid exfoliation of micrometer-sized layered h-BN crystals to 2D h-BN nanosheets is depicted in FIG. 2A. The transmission electron microscopy (TEM) of the exfoliated h-BN is shown in FIG. 2B. The h-BN powder is exfoliated into thin layers containing few atomic layers (i.e., 5-10 layers). More TEM and HR-TEM images for further evidence are provided in FIG. 6.

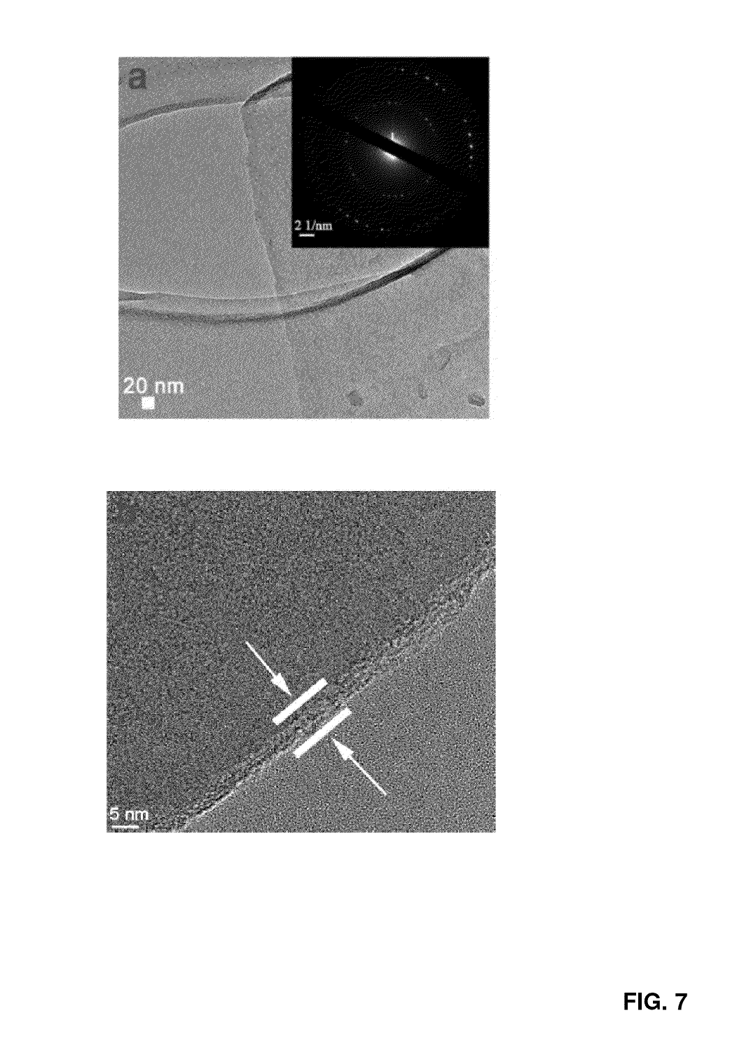

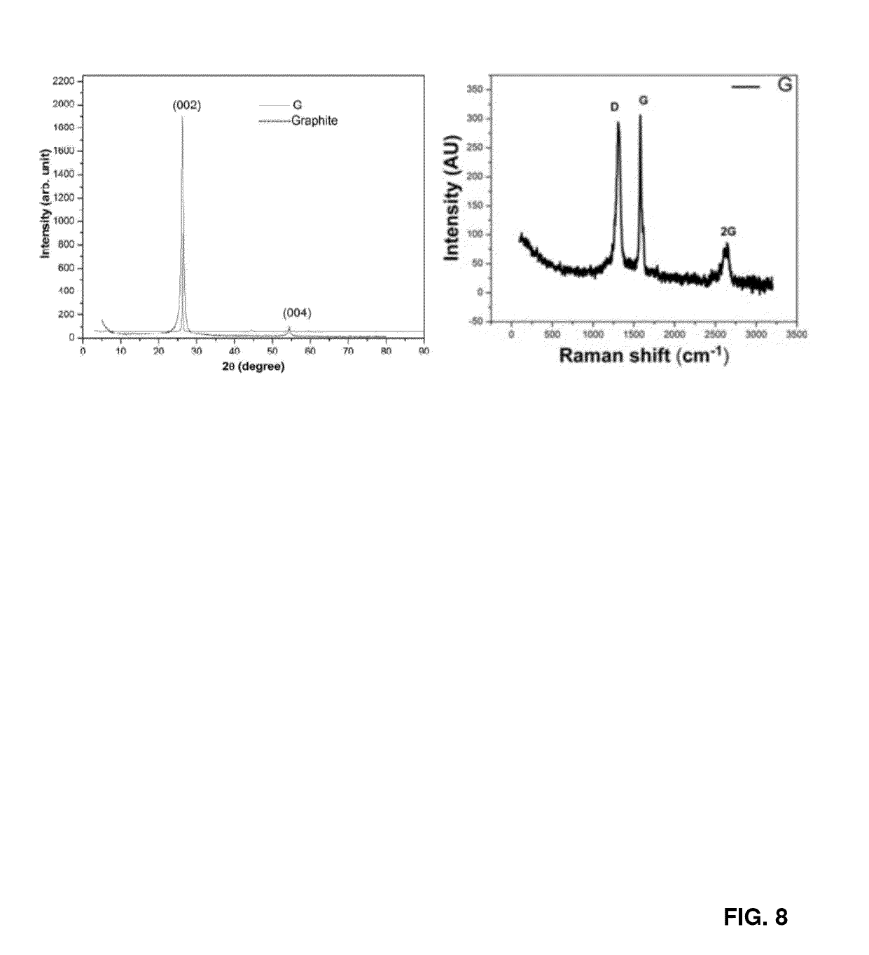

The corresponding selected area electron diffraction (SAED) is shown in the inset of FIG. 2B. The diffraction rings show the crystallinity of the h-BN layers with rotational disorder. The TEM and HRTEM images of exfoliated graphite (graphene, G sheets) are shown in FIG. 7. The X-ray diffraction (XRD, using Rigaku Cu Ka) pattern of h-BN is depicted in FIG. 2C (that of graphene is provided in FIG. 8). The XRD of dried h-BN nanosheet powders shows a prominent (002) peak indicating a maximum exposure of 002. Raman spectrum of h-BN at 1369 cm⁻¹ originates from E_{2g} mode of B—N bond vibration, as seen in FIG. 2D. The Raman spectrum of graphene shows the disorder-induced D peak at 1350 cm⁻¹, G peak at 1595 cm⁻¹, and 2D peak at 2695 cm⁻¹ (FIG. 8).

### Example 1.2

### Preparation of h-BN/MO and Graphene/MO Nanofluids

Both h-BN/MO and Graphene/MO nanofluids were synthesized by the liquid exfoliation method. The micrometer-sized h-BN powder purchased from Sigma Aldrich (1 pm, 98%) was extensively sonicated (3 h) in isopropyl alcohol (IPA, room temperature surface tension ˜23 mN/m), keeping the temperature (300 K) of the sonicator water bath constant. After sonication, the solution was centrifuged for 30 min with a high rate of 1,500 rpm. The whitish supernatant was collected and vacuum-filtered. The collected white powder was re-dispersed in MO by sonication at room temperature.

The graphene (G) was prepared by the same liquid exfoliation method using graphitic powder (Bay Carbon, Inc. SP-1 grade 325 mesh). Dimethyl formamide was used as the exfoliation medium (room temperature surface tension ˜37 mN/m). The initial powder was sonicated for 3 h, and the resultant solution was centrifuged at a high rate of 3,000 rpm. The resultant blackish supernatant was collected and filtered, and the powder was redispersed in MO by sonication at room temperature. Surfactants were not used in both cases.

### Example 1.3

### Characterization of h-BN/MO Nanofluids

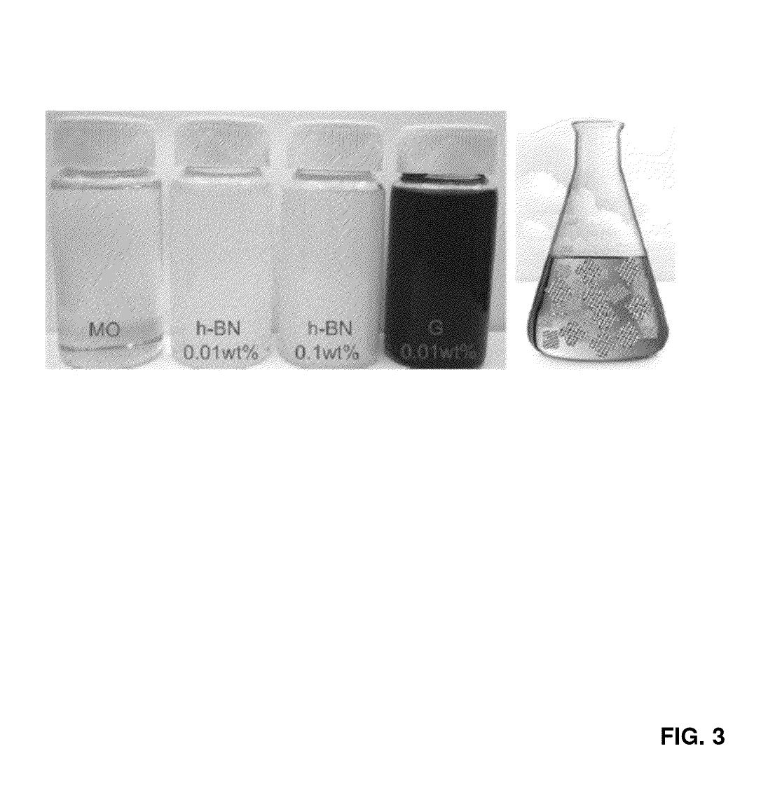

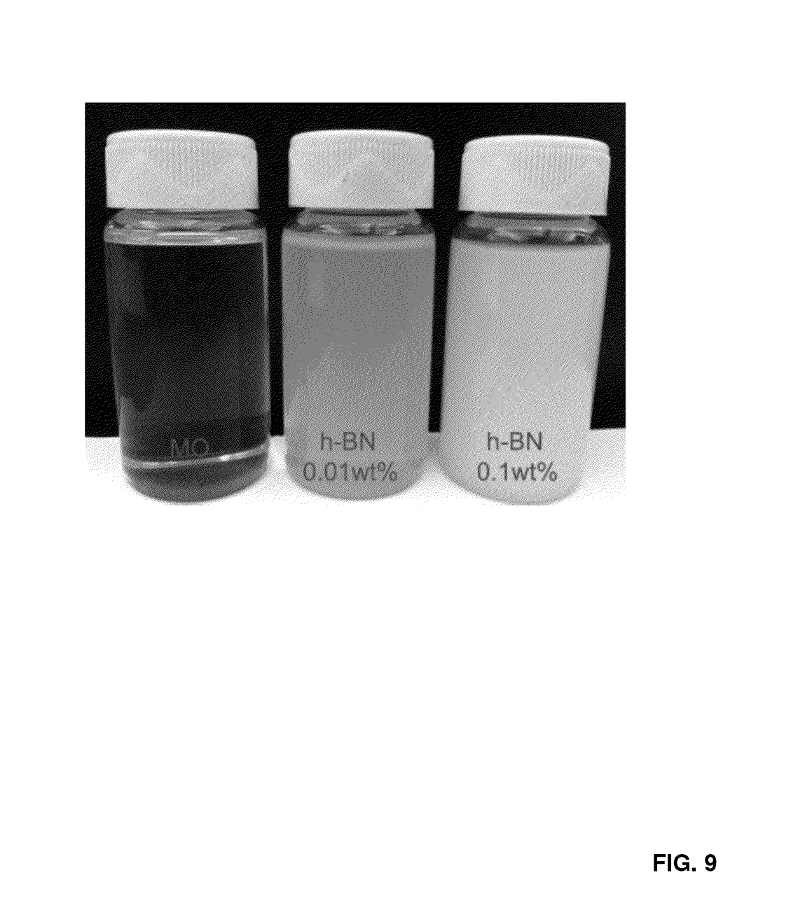

Photographs of various nanofluids containing h-BN crystals are shown in FIG. 3. A similar photograph in a dark background is provided in FIG. 9, showing the transparency of h-BN/MO in two different concentrations.

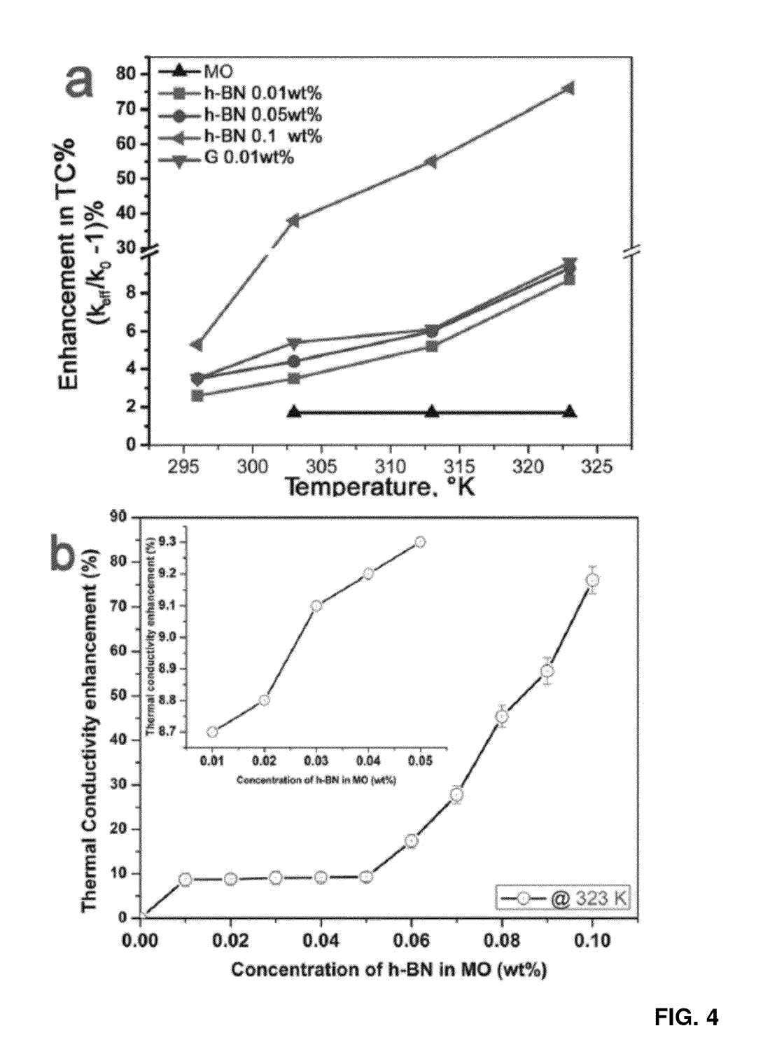

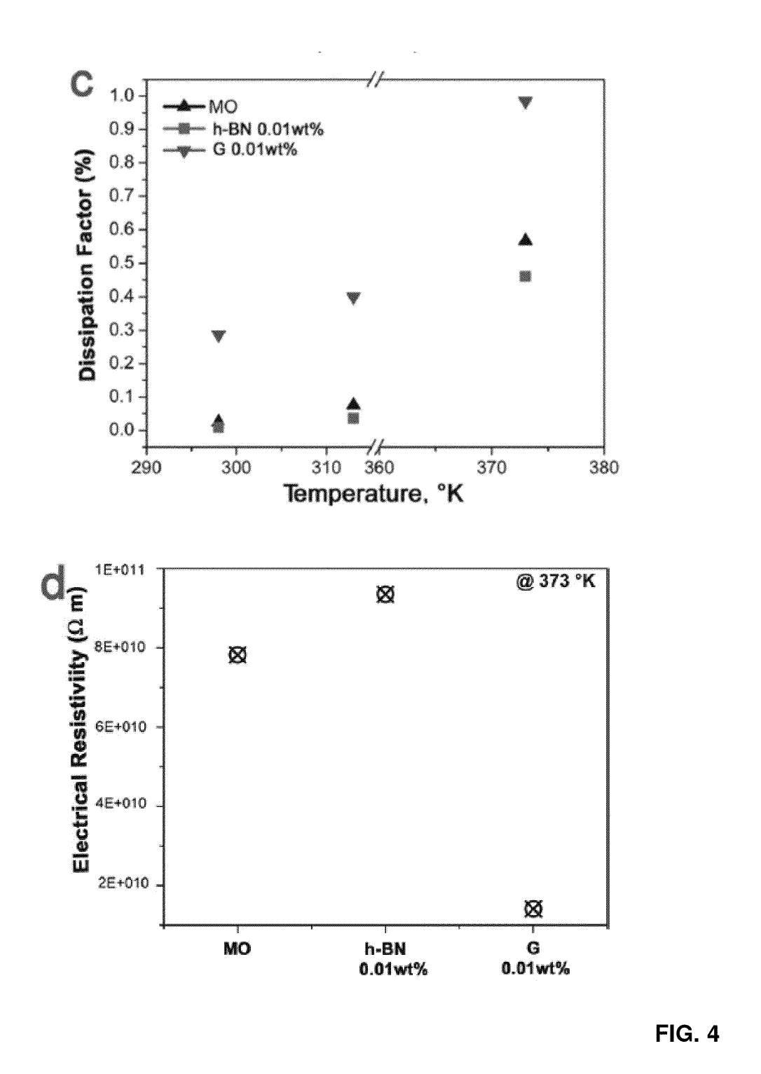

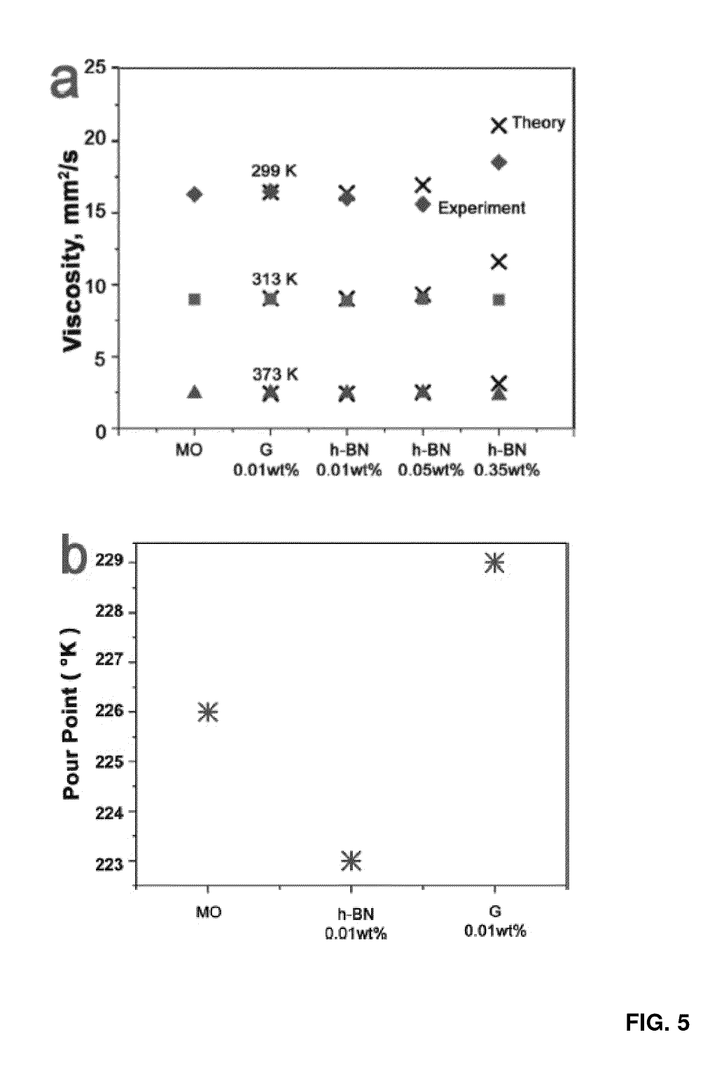

FIG. 4 provides data relating to the thermal and electrical properties of various nanofluids containing different concentrations of h-BN. FIG. 5A depicts the correlation of experimental and theoretical viscosity values of nanofluids. FIG. 5B shows the experimental pour point values of MO, h-BN/MO, and graphene/MO.

The nanofluid with low filler fractions of h-BN (0.01-0.10 wt. %) is highly stable in MO with a high shelf life (found to be stable even after 3 months) without any surfactant. The zeta-potential (measured using Malvern Zen 3600 Zetasizer (Zetasizer Nano)) of the 0.10 wt. % h-BN/MO nanofluid is found to be around 22 mV, indicating the stability of the nanofluid.

As set forth in more detail herein, Applicants have substantiated the stability of the fluid using viscosity measurements. However, the graphene nanofluid is relatively less stable with a relatively low zeta-potential value of about 10 mV.

Without being bound by theory, it is envisioned that the exfoliated layers of h-BN can be stabilized in MO via molecular interactions as well as Brownian motion. The interaction of oleophilic layers (particularly that of h-BN) with the MO can contribute to the enhanced stability of the suspensions. The high hydrodynamic radius of about 1000 nm found from dynamic light scattering studies (DLS) of h-BN/MO and graphene/MO (1300 nm) also suggests interaction between layers due to their oleophilic nature.

The possible interaction between exfoliated layers and MO is further studied via viscosity measurements, theoretical modeling, and pour point evaluation. FIG. 4A shows the temperature-dependent thermal conductivities of both h-BN/MO and graphene/MO fluids at various weight percentages of the fillers. The thermal conductivity of MO (at room temperature, thermal conductivity is ˜0.115 W/mK, agreeing well with standard values reported) did not show any temperature dependence, as reported by others. However, the nanofluids show a temperature-dependent variation in the thermal conductivity, indicating the role of nanoparticles in thermal conductivity.

Effective thermal conductivities (kₘ) of nanofluids increases with temperature (measurements are done from room temperature to 50° C.), indicating the role of Brownian motion on thermal conductivities measured, in accordance with Maxwell predictions. Other factors influencing the k of nanofluids is the liquid layering and viscosity. Without being bound by theory, it is envisioned that the oleophilic nature of h-BN allows for good interfacial interaction (layering) with MO, as is inferred from the enhanced hydrodynamic radius from DLS studies. The liquid layering at the particle-liquid interface is predicted as an important mechanism for effective thermal conductivity enhancement in nanofluids by many researchers.

The viscosity of the h-BN containing nanofluids decreases significantly with temperature (from 16 mm²/s at room temperature to 2.2 mm²/s at 100° C. (FIG. 5A), while the enhancement in viscosity with the addition of nanofillers is very small. This is an added advantage of the low filler fractions since the increase in viscosity will decrease the effective thermal conductivity values as well as flow characteristics of the fluid.

Furthermore, the h-BN containing nanofluids are stabilized in the carrier fluid (MO) without any surfactant. The surfactants can decrease the thermal conductivity of the nanofluids since surfactants introduce defects at the interfaces. The free phonon/electron movement is affected by these defects, and hence a surfactant-free stable suspension can provide much better thermal conductivity in some embodiments.

FIG. 4A shows the enhancement in thermal conductivity with the increase in weight fraction of h-BN or graphene and increase in temperature of measurements. The 0.10 wt. % h-BN/MO shows an enhanced thermal conductivity ((kₑ/k_{f})−1) % of ˜76%. The morphology of nanofillers can strongly influence the thermal conductivity of the nanofluid. The volume fractions and conductivities of two phases can determine the upper (where the nanofillers will form continuous phase) and lower (carrier fluid serves as the continuous phase) boundary values of the effective thermal conductivity of the nanofluid. A theoretical model of the effective thermal conductivity of the h-BN/MO nanofluid is performed using a classical effective medium theory known as Hashin-Shtrikman (H-S) theory. In both cases, for h-BN/MO or graphene/MO, the ratio of kₚ/k_{f} is >1, where kₚ is the thermal conductivity of h-BN or graphene and k_{f} is the thermal conductivity of MO. The lower boundary value (since the nanofillers fraction is very low, 0.01 wt. %) for effective thermal conductivity of h-BN/MO, kₑ is calculated using the following equation:

$$\frac{{k}_{e}}{{k}_{f}} = 1 + \frac{3 ϕ ( \frac{{k}_{p}}{{k}_{f}} - 1 )}{\frac{{k}_{p}}{{k}_{f}} + 2 - ϕ ( \frac{{k}_{p}}{{k}_{f}} - 1 )} \qquad ( 1 )$$

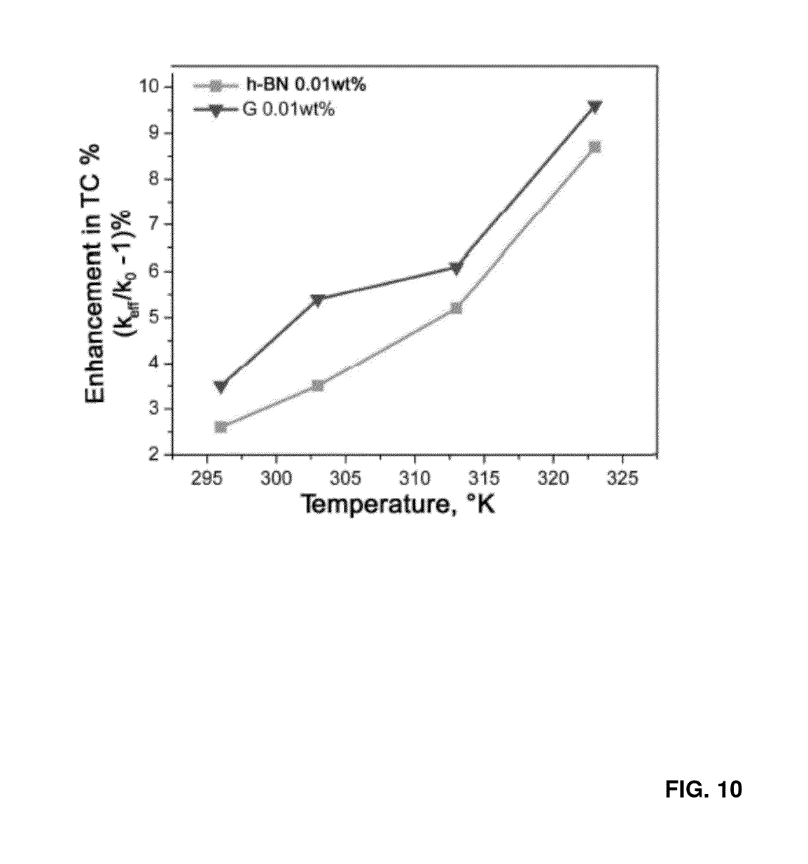

The calculated value of 0.1184 W/mK matches well with the lowest experimental value obtained for 0.01 wt. % h-BN/MO nanofluid (0.119 W/mK). It has been demonstrated that clustering of the nanofillers can increase the thermal conductivity of nanofluids. The clustering effect is relatively higher in graphene/MO, and hence, it is relatively less stable than h-BN/MO. This is also inferred from dynamic light scattering studies (size—1300 nm) and HRTEM studies. This can be the reason for slightly higher thermal conductivity values for graphene/MO than for h-BN/MO (for more details, see FIG. 10, showing ˜1% enhancement in effective thermal conductivity for graphene/MO compared to h-BN/MO), although graphite and h-BN have the same bulk thermal conductivity values. Moreover, the percentage of enhancement in thermal conductivity obtained for 0.01 wt. % graphene/MO nanofluid is in agreement with that of recently reported values for graphene-based nanofluids.

FIG. 4B shows the variation in measured thermal conductivity at 323 K (50° C.) for different h-BN/MO fluids with varying h-BN concentration. The thermal conductivity of h-BN/MO fluids is found to be gradually increased with h-BN filler concentration, from 0.01 to 0.10 wt. %. Without being bound by theory, it is envisioned that this high thermal conductivity value even at smaller filler concentrations is due to the high surface area of h-BN sheets. The increase in thermal conductivity with filler fractions indicates that at higher concentrations, it is not following Maxwell's classical theory where it will not vary much with concentration, while they follow a network model like graphene fluids. This indicates the contribution of percolation mechanism for thermal conductivity.

Moreover, like graphene fluids but unlike graphene oxides or CNT fluids, the thermal conductivity of h-BN/MO fluids increased with temperature (FIG. 4A). However, the temperature-dependent variations in thermal conductivity indicate that it is not just the percolation mechanism that increases the thermal conductivity, as explained in the network model, but Brownian motion also contributes to the thermal conductivity of h-BN and graphene 2D material-based nanofluids. The thermal conductivity measurements above 323 K (50° C.) are also carried out. The percentage of enhancement in thermal conductivity for 0.10 wt. % h-BN/MO nanofluid at 373 K (100° C.) ranges from 80 to 100% in different measurements. The wide range in thermal conductivity values obtained at higher temperatures (>50° C. for oil based nanofluids) is due to the enhanced free convection at higher temperatures. Hence, even though it is apparent that the thermal conductivity of the h-BN/MO nanofluid is enhanced at high temperatures (>50° C., the accurate percentage of enhancement may be difficult to measure).

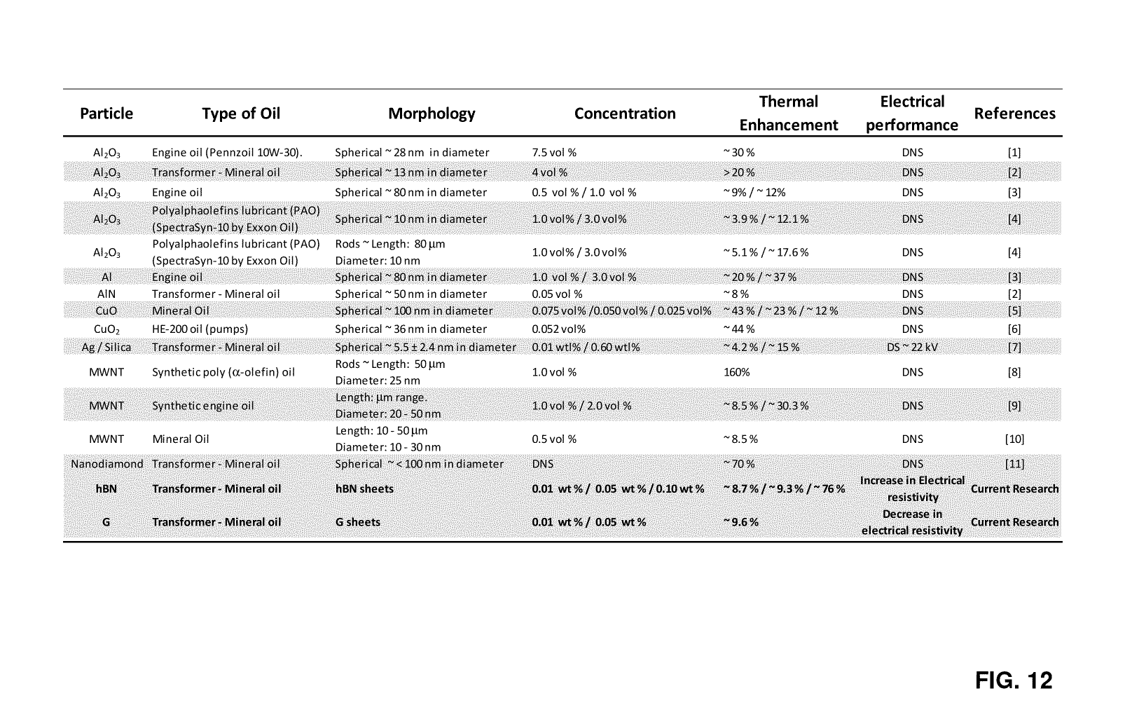

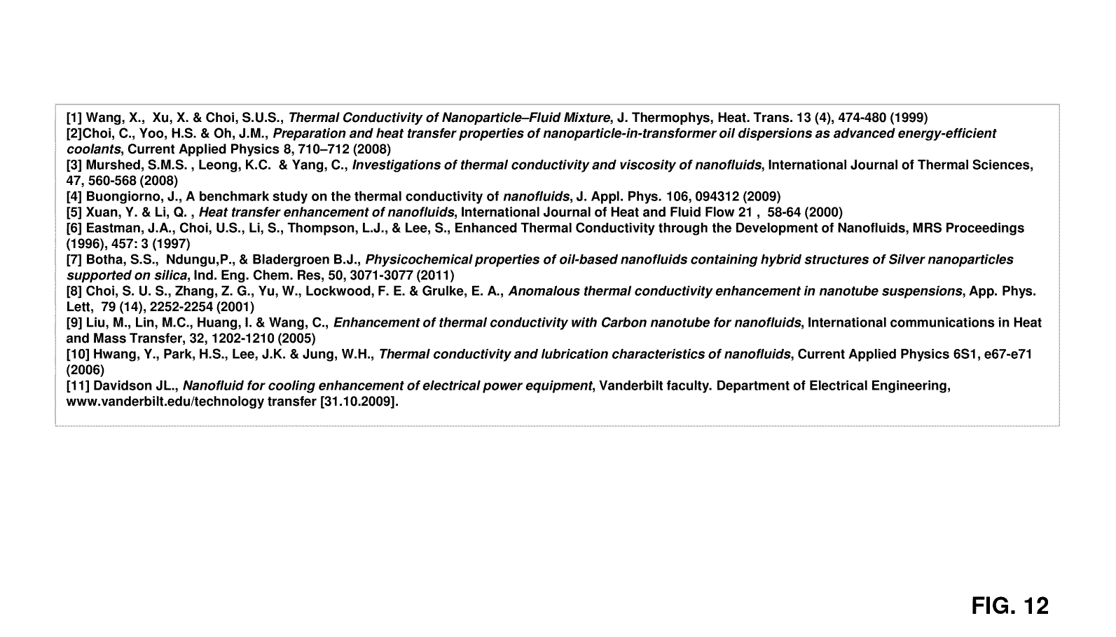

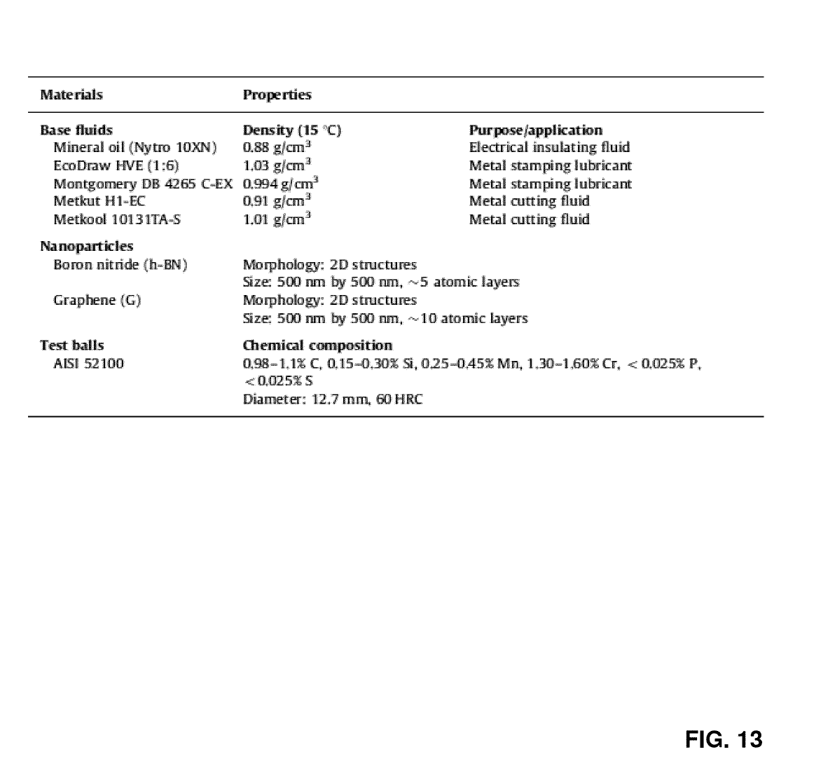

The use of nanofluids for thermal management in electrical devices, such as transformers, also necessitates the study of their electrical properties. The dissipation factor (DF) or liquid power factor, which is a measure of the dielectric loss in the system under the presence of an alternating electric field, is measured (liquid power factor using ASTMD-924 and % DF using ASTMD-1169; measurements have been done at 2000 V and 60 Hz; the values match in both cases) for various nanofluids and is plotted in FIG. 4C. h-BN/MO exhibits the lowest DF, while graphene/MO exhibits an enhanced value compared to MO at all measured temperatures. Since DF represents the ratio of equivalent series resistance (ESR) to capacitive reactance, the decrease in DF indicates the decrease in dielectric losses in the material. The electrical resistivity (ASTM D1169) of the nanofluids is also found to be affected by various nanofillers (FIG. 4D). The h-BN/MO exhibited higher resistivity (9.35E10 Ωm), while graphene/MO showed lower resistivity (1.41E10 μm) compared to MO (7.82E10 Ωm). This is understandable as h-BN is electrically insulating, while graphene is electrically conducting. These studies are important for the development of nanofluids for thermal and electrical management. The comparison of our obtained results for h-BN/MO with the existing literature (various nano-fillers with different morphology) indicates that this is a leap in the development of highly thermally conducting nanofluids with lower filler fractions but without losing the electrically insulating properties of the base fluid. A detailed survey on the development of oil-based nanofluids for thermal management is shown in FIG. 12.

To further understand the stability of the nano-fluid, shear viscosity studies were conducted with a TA Instruments ARES rheometer (FIG. 5A). Temperature-dependent shear viscosity measurements for different concentrations of h-BN/MO (viscosity measurements of 0.01 wt. % graphene/MO also shown for comparison) are shown in FIG. 5A. MO behaves like a Newtonian fluid since its viscosity is independent of shear rate, and the viscosity of MO decreases with increasing temperature. Addition of h-BN up to 0.05 wt. % to MO does not measurably alter its viscosity for the entire range of temperatures tested. At 298 K (25° C. and 0.35 wt. % of h-BN), the viscosity increases, but the behavior of the fluid is still Newtonian. Newtonian behavior in solutions of nanoparticles indicates that the interactions between the particles are weak. This suggests that the h-BN/MO nanofluids are relatively stable colloidal systems. Moreover, the relatively small increase in viscosity (<30%) at 0.35 wt. % is evidence that the solution is not flocculating. This enhancement in viscosity is consistent with the theoretical predictions of Hinch and Leal for dilute solutions of non-interacting oblate spheroids (considering the layered morphology of h-BN and graphene), for which the viscosity is described by the following equation:

$$η = ( \frac{32}{15 π} ) ( \frac{φ {η}_{s}}{p} ) + {η}_{s} \qquad ( 2 )$$

In the above equation, φ is the volume fraction of nanoparticles in solution, ηₛ is the solvent viscosity, and ρ is the dimensional ratio (the shortest nanoparticle dimension to the largest one). In order to calculate ρ, the largest dimension of the nano-particles was measured with dynamic light scattering. Assuming the h-BN and graphene have a thickness of around 4 nm (few-layered graphene and h-BN, inferred from the High Resolution TEM images), the corresponding p values are 0.008 for h-BN and 0.006 for graphene. The theory agrees well with the experimental rheological data (FIG. 5A), suggesting that the average number of layers of h-BN and graphene in MO is around 10. The pour point, which is the lowest temperature at which the fluid can flow (pumpable temperature), seems to be affected by the nanofillers of h-BN and graphene (FIG. 5B), showing that it is not just a colligative property but also depends on the nature of nanofillers (for h-BN/MO, pour point is lowered, and for graphene/MO, pour point is enhanced) and intermolecular interactions. The lowering of the pour point can be attributed to the nanoscale dimensions of the fillers (here h-BN) and high intermolecular interactions and liquid layering (MO) with the h-BN. The h-BN could substantially increase the thermal conductivity of MO while lowering the pour point of MO, which are both desirable properties of heat-transfer fluids. Without being bound by theory, it is envisioned that small deviations from the theoretical values of viscosity at higher concentrations of h-BN may be a result of a transition from a dilute to a semi dilute phase, or due to the onset of some small aggregation between the h-BN nanosheets.

In sum, Applicants have demonstrated herein a stable Newtonian nanofluid with 2D fillers of h-BN in a mineral oil, normally used in transformers, having high thermal conductivity. The h-BN/MO nanofluid is also an electrically insulating fluid and has a lower freezing point than the pure MO. The h-BN/MO results are compared with graphene/MO, which appears to be more electrically conductive though it is also highly thermally conductive. Applicants' electrical and thermal analysis of these unique h-BN/MO fluids shows that these may possibly be the next generation thermal nano-oils for lubrication, capable of efficient thermal management in heavy duty machinery such as transformers.

### Example 1.4

### Thermal Conductivity Measurement Setup

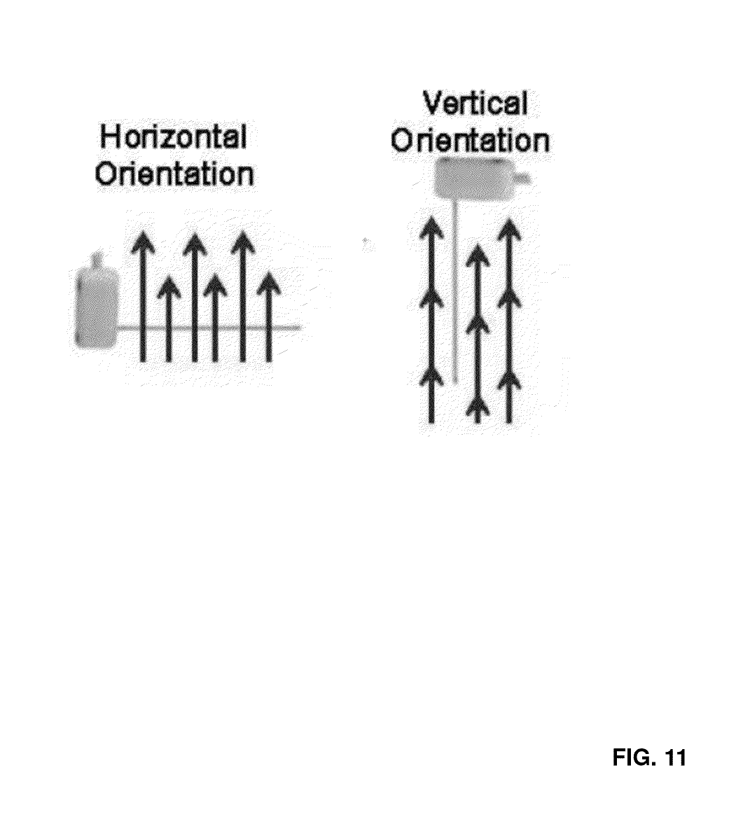

Thermal conductivity measurements on h-BN and graphene nanofluids of different weight percentages were carried out using a KD2 probe (Decagon Device Inc., model KD2 Pro). This device is based on the transient hot-wire (a fast and accurate method for fluid thermal conductivity measurements), where a finite length wire is completely immersed in a finite fluid medium and the wire is electrically heated. While the wire is heating up, the change in resistance (thus its temperature) is measured as a function of time using a Wheatstone bridge circuitry. The thermal conductivity (TC) value is determined from the heating power, and the slope of the temperature change with logarithmic time scale. The instrument uses a 1.3 mm diameter by 60 mm long stainless steel probe (KS-1 probe) that is completely immersed in the nanofluid to obtain the effective thermal conductivity (kₑ) of nanofluids. This probe has been calibrated using a standard fluid, glycerol, and the conductivity value is verified up to 3 decimal points. Temperature-dependent measurements were done using a thermal bath, and samples were thermally equilibrated before each measurement. The measured values are compared with the base fluid (MO) thermal conductivity (k_{f}). The possible errors due to the free and forced convection mechanisms have been minimized by aligning the sensor orientation in the vertical direction with the fluid sample container (error due to free convection, g is proportional to 1/d, where d is the characteristic dimension of sensor and d is higher in the vertical orientation of the sensor (the role of alignment of sensor probe in the measurement is illustrated in FIG. 11) and vibration isolation of the measurements, and moreover, the higher viscosity of MO than water also minimizes the error due to free convection. Thermal conduction happens through direct molecular interactions and there is no bulk fluid flow. However, convection heat transfer occurs when there is bulk fluid flow. Hence, during measurements, it is necessary to isolate all kinds of convection mechanisms that can contribute error to the thermal conductivity measurement.

The alignment of the probe is important during thermal conductivity measurements to minimize the error due to free convection. As mentioned previously, error due to free convection, δg, is proportional to 1/d, where d is the characteristic dimension of the sensor. Hence, it is desirable to maximize d. The characteristic dimension d depends on the fluid flow. If the fluid is heated while keeping the sensor horizontal (the sensor will heat the surrounding fluid), the density gradient will allow the fluid to flow upwards (across the needle). In that case, the characteristic dimension for the KS-1 probe is 0.127 cm (diameter of the needle). If the sensor is oriented vertically, the density variation will allow the fluid to flow upwards and in this case the characteristic dimension, d is 6 cm. Hence vertical sensor orientation will maximize the d and will minimize the error due to free convection.

### Example 2

### Tribological Properties of h-BN Containing Nanofluids

Friction plays a key role in diverse processes such as drilling, cutting, working pair components, and working pair mechanisms. Wear is the major cause of material and energy loss in mechanical processes, as components are in constant friction. Lubricants can be used to minimize contact friction between components, resulting into considerable energy and tooling savings. See, e.g., Stachowiak, A. W. Batchelor, Engineering Tribology, third ed., Elsevier Butterworth-Heinemann, Oxford, UK, 2005. However, frictional heat generated when two or more moving surfaces are in contact can degrade lubricants or oxidize them. Thus, it is desirable for the generated heat to be dissipated rapidly.

Nanoparticles could be deposited on the rubbing surface and improve the tribological properties of conventional lubricants and metal-cutting fluids, showing the contribution of friction and wear reduction by dispersed nanoparticles. On the other hand, generated heat during the frictional loss needs to be drawn out from the system in an efficient manner. Thus, a good lubricant must possess adequate thermal conductivity (TC).

Recently, two-dimensional nanomaterials (2D) received scientific attention due to their unique physical properties and high surface areas. The large-scale wet chemical synthesis of these 2D nanomaterials found applications in various composites. The bulk counter parts of some of these 2D materials (e.g., graphene) have established lubrication properties. As set forth in Example 1, Applicants have discovered that hexagonal boron nitride (h-BN) has very similar properties to graphene for tribology performance and heat transfer as a nanofluid (i.e., nanoparticle additives to a base fluid).

In this Example, Applicants evaluate the multifunctional aspects of utilizing h-BN in various fluid compositions. Applicants have observed that fluid compositions containing h-BN can be simultaneously used for thermal management and contact friction. Tribological improvement of NFs with 2D-nanosheets is first substantiated with a mineral oil (MO) based nanofluidic system and then generalized with other common nanofluids (e.g., lubricating fluids, metal-cutting fluids, and drilling fluids).

The tribological properties of h-BN containing NFs were tested by a ITEePib [ref.: Institute for Sustainable Technologies—National Research Institute, <www. tribologia.org/ptt/inst/rad/ITeE-PIB.htm>] Polish method using a four-ball tribotester for testing lubricants under scuffing conditions and the ASTM D5183 method [ref.: ASTM International D5183-05, Standard Test Method for Determination of the Coefficient of Friction of Lubricants Using the Four-Ball Wear Test Machine, 2011]. These two tests were compared in order to determine if the Polish method showed similar results to the ASTM method.

Shear viscosity studies were conducted with a TA Instruments ARES rheometer. Temperature dependent shear viscosity measurements for different concentrations of fluids reinforced with h-BN (viscosity measurements of 0.01 wt. % G also shown for comparison) were performed.

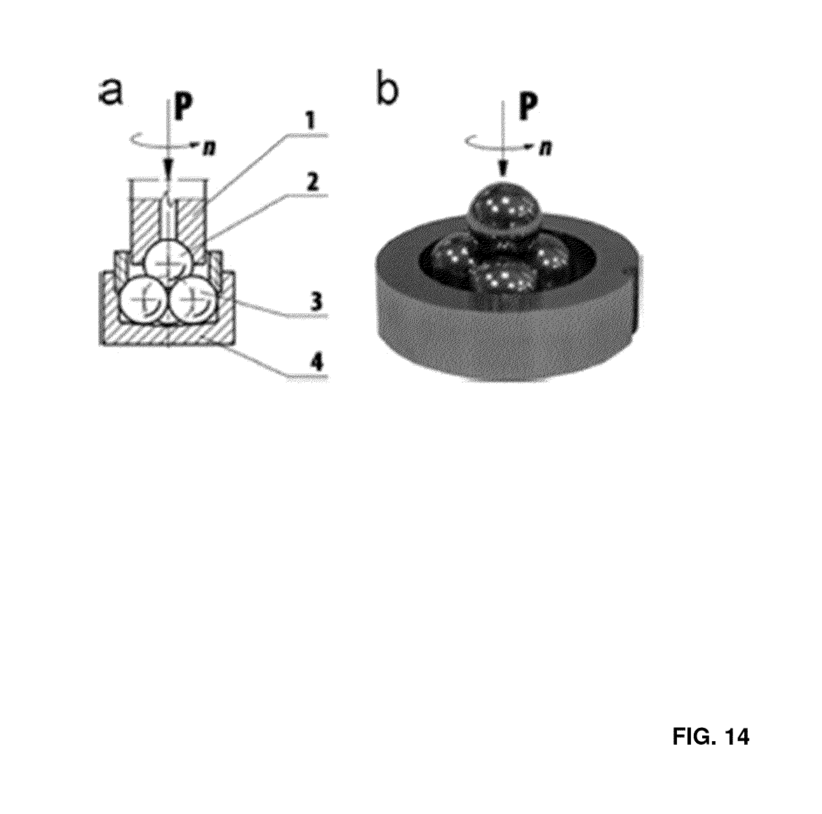

A tribotester (T-02) with a four-ball fixture was used to determine the anti-wear properties of lubricants under pressure and controlled temperature. As illustrated in FIG. 14, machine operation involves four steel balls. Steel ball 2 rotates with a speed n to apply a pressure with a load P. Three additional balls 3 are secured by a holder 4. The ball test material was an AISI 52100 steel with a 12.7 mm diameter, and a hardness of 60 HRC.

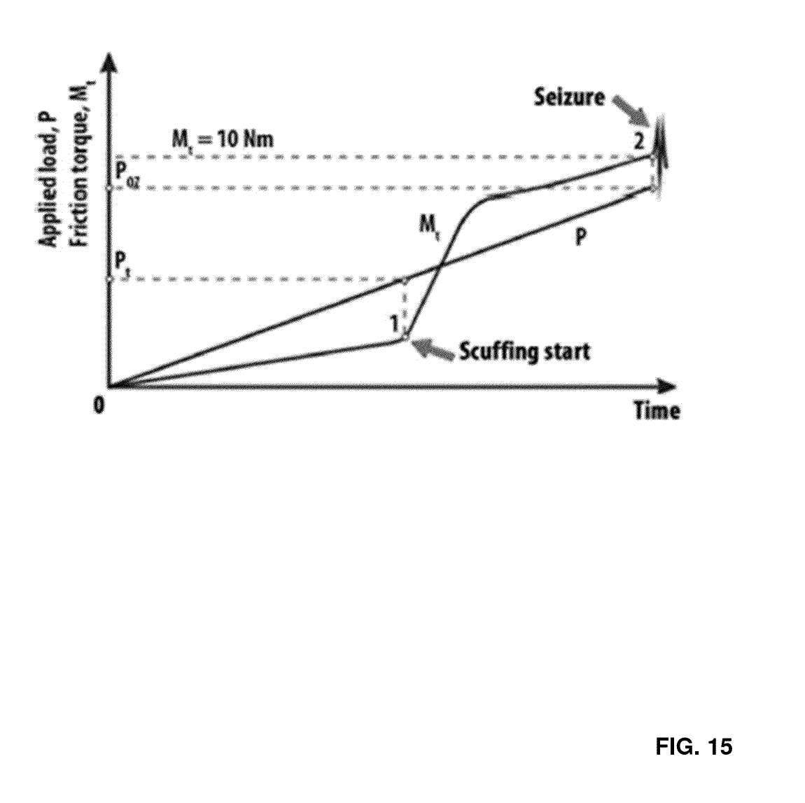

Using this tribotester, the ITEePib [ref.: J. N. Colleman, M. Lotya, A. O'Neill, S. D. Bergin, P. J. King, U. Khan, K. Young, A. Gaucher, S. De, R. J. Smith, et al., Two-dimensional nanosheets produced by liquid exfoliation of layered materials, Science 331 (2011)_{—}568-571] Polish method for testing lubricants under scuffing conditions can be used to determine the friction torque, the maximum applied load, and the temperature of the lubricants. The results obtained are summarized in the chart shown in FIG. 15. This chart helps to identify the extreme pressure properties of NFs, namely the time and load when the wear and the loss of film lubricant occur.

The ITEePib Polish method shows a p_{oz} indicator, the pressure loss limit of lubricant film. See FIG. 15. The seizure appears when the film lubricant disappears because of the increment of load. At that moment, the lower and upper balls of the machine shown in FIG. 14 have a metal-metal contact. The wear scar diameter (WSD) of the 3 stationary balls are measured by an optical microscope and used to calculate p_{oz}. This parameter is calculated as follows: p_{oz}=0.52 (P_{oz}/WSD²), where p_{oz} is the limiting pressure of seizure (N/mm²) (higher values are expected). P_{oz} is the seizure load (Newton, N), which is desirably measured to the nearest 100 N. The 0.52 coefficient results from the force distribution in the four-ball tribosystem. It is envisioned that, the greater p_{oz} value, the better action of the tested lubricant under scuffing conditions.

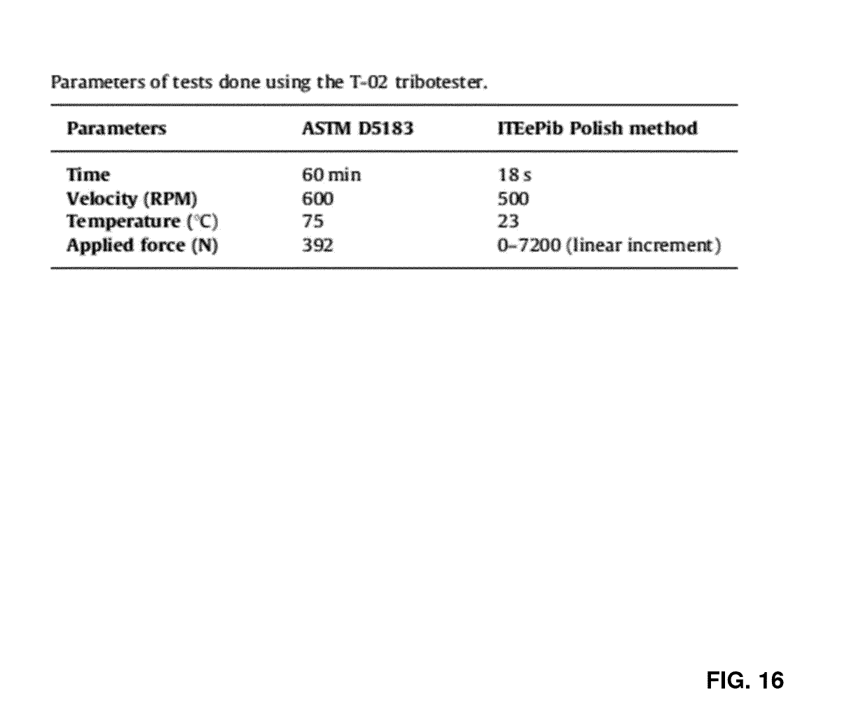

ASTM D5183 [ref.: ASTM International D5183-05, Standard Test Method for Determination of the Coefficient of Friction of Lubricants Using the Four-Ball Wear Test Machine, 2011] methodology can also be applied on tribotester T-02 to determine the coefficient of friction (COF) and WSD of diverse lubricants under constant load conditions. The parameters for each test are shown in FIG. 16.

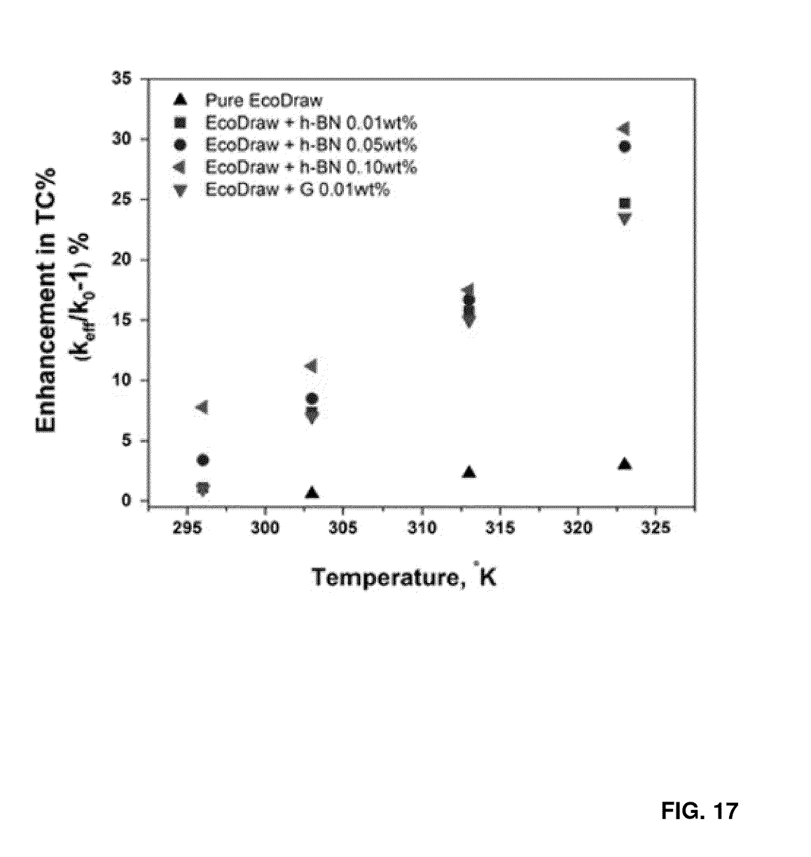

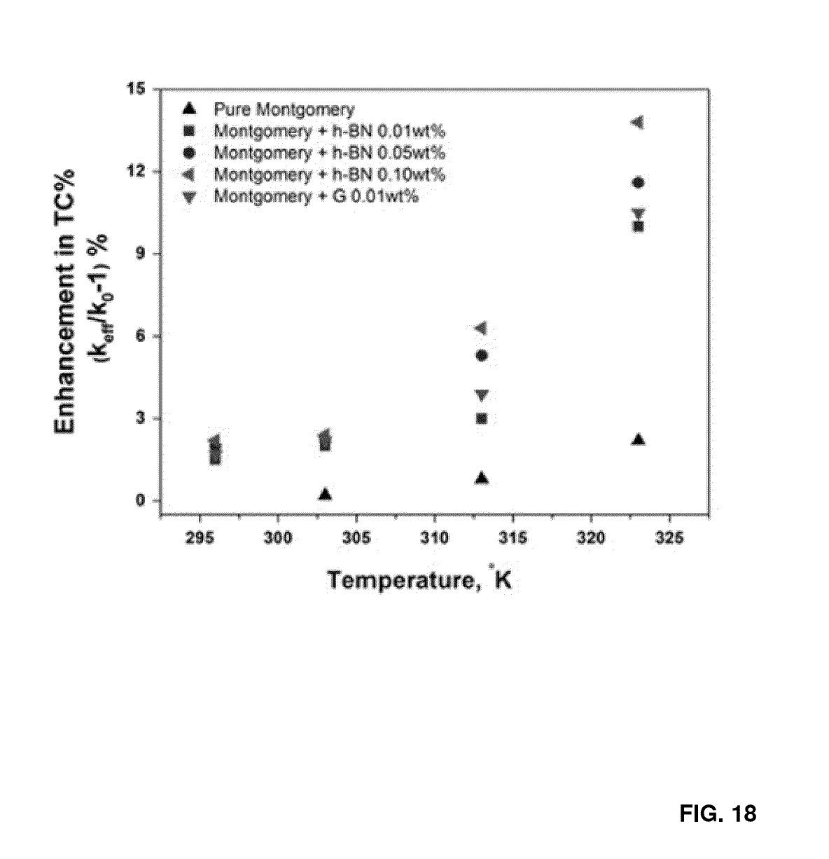

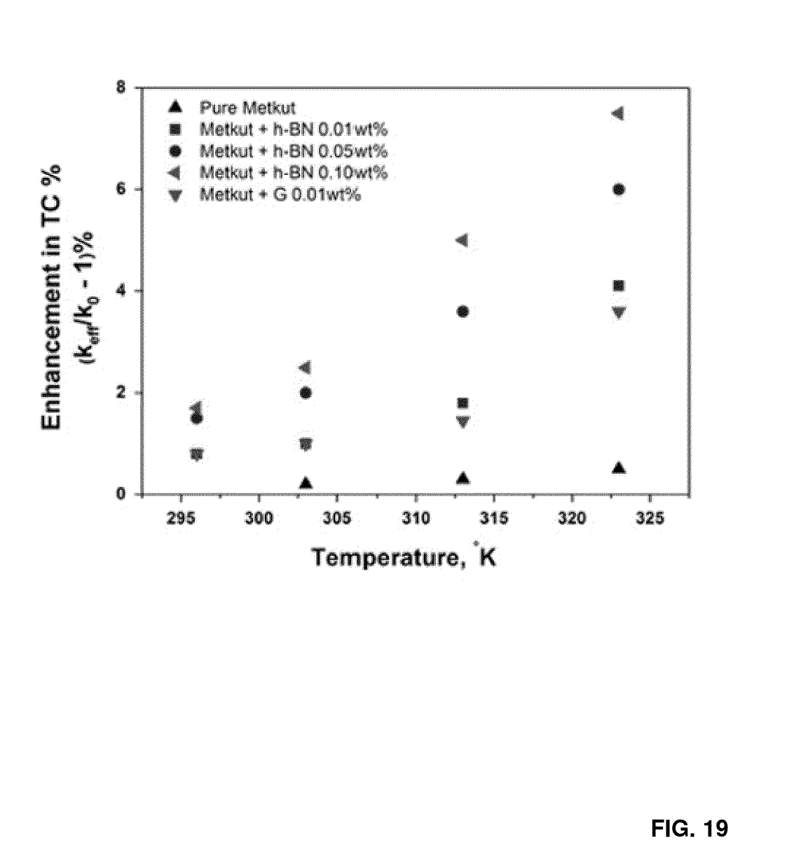

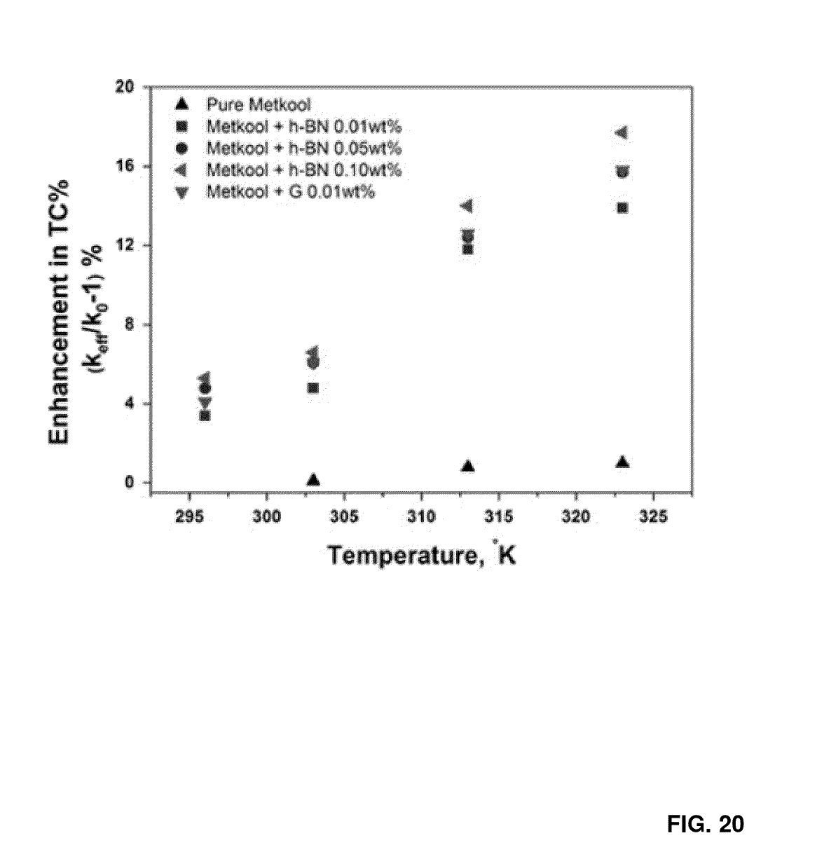

Temperature-dependent thermal conductivity (TC) for h-BN and G reinforced lubricants and metal-cutting fluids at various weight percentages are shown in FIGS. 17-20 of this invention disclosure. The k_{eff} of NFs increases with temperature (measurements performed from room temperature to 501° C. (323 K)). Without being bound by theory, the results indicate the role of Brownian motion in TC enhancement. At the same time, the results exhibit an enhancement with increase in filler fraction, revealing the role of percolation mechanisms as it is observed for other oil-based samples. These nanofluids show a temperature dependent variation in the thermal conductivity, indicating the role of nanoparticles in TC. Moreover, for oil based samples, liquid layering at the particle/liquid can also contribute to the enhancement in TC.

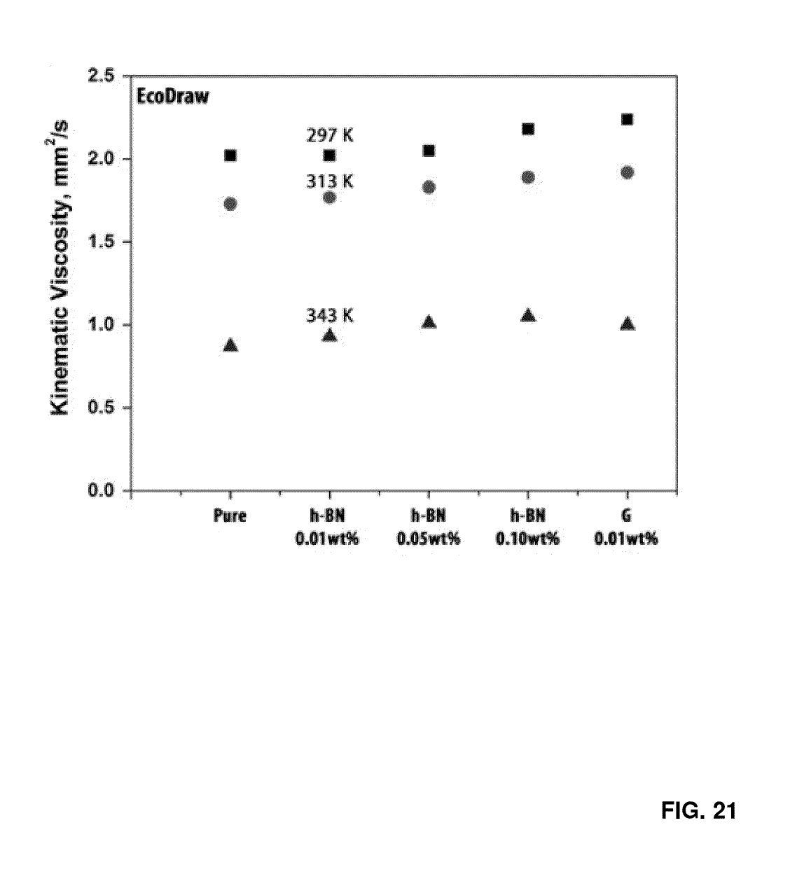

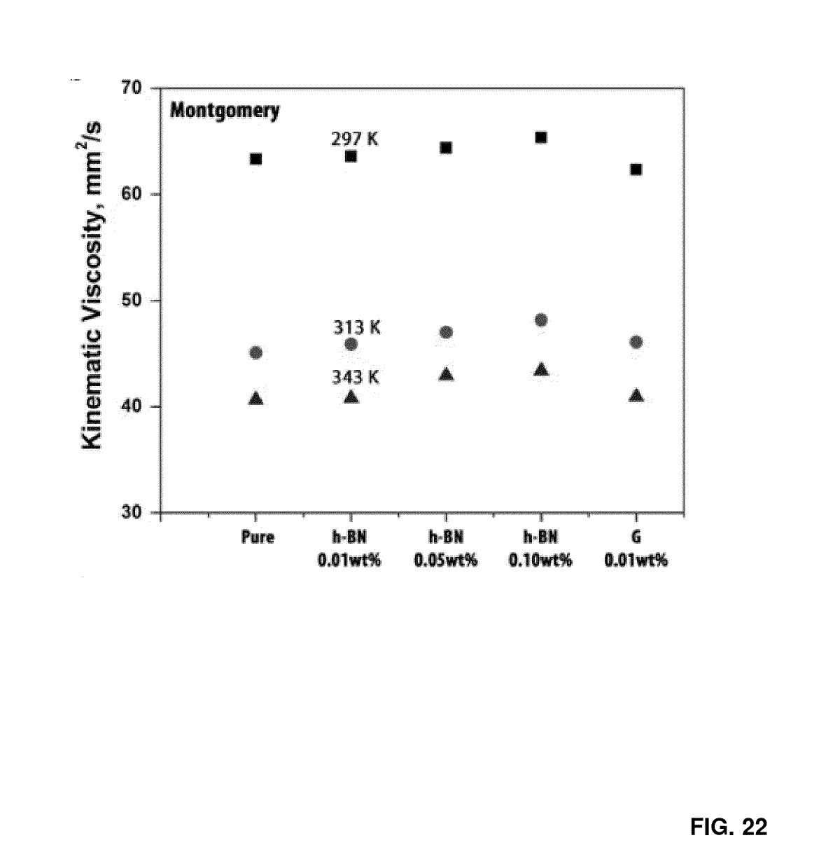

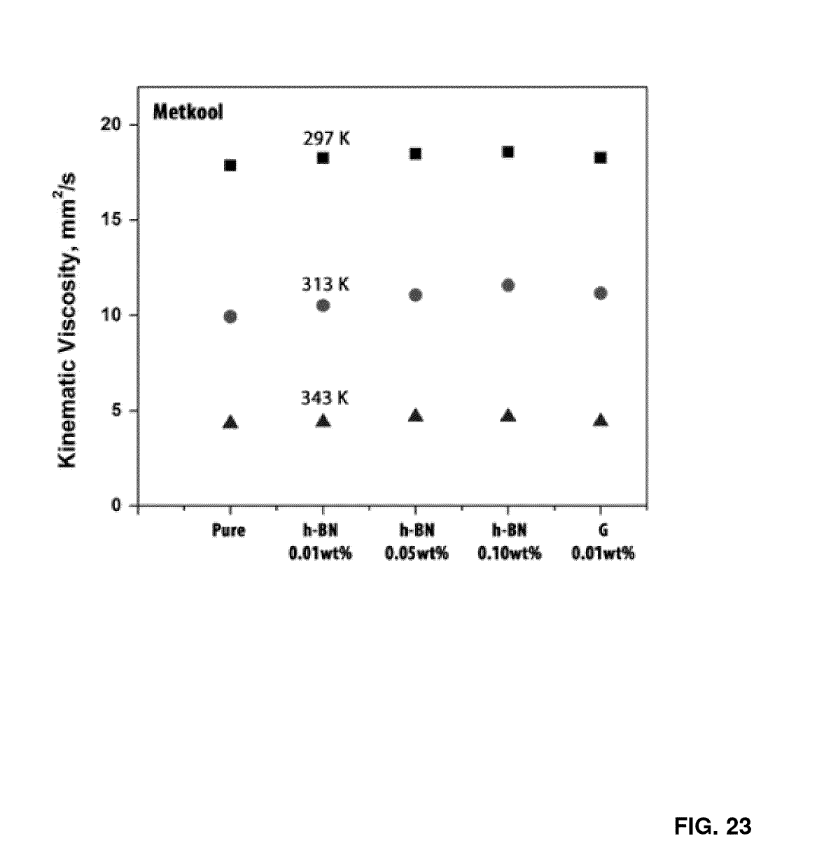

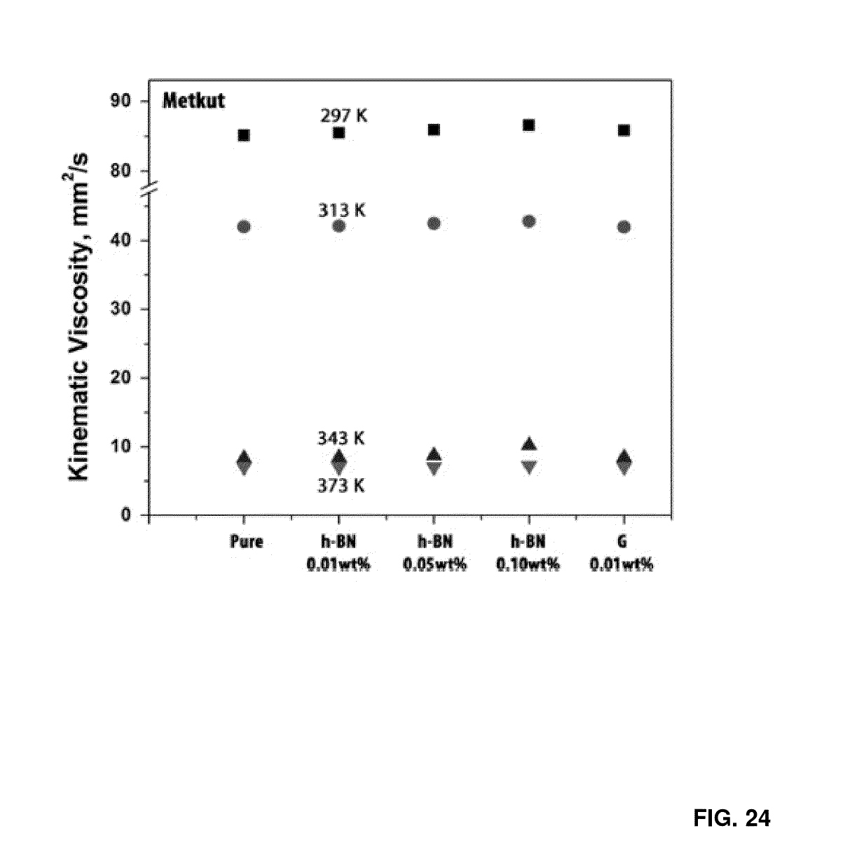

In general, it is envisioned that viscosity plays an important role in the aforementioned fluids. In particular, Applicants have observed that viscosity decreases significantly with increase in temperature, as shown in FIGS. 21-24. Applicants have also observed that the enhancement in viscosity with the addition of the nanofillers is very small (in low filler fractions). Such a small enhancement in viscosity is an advantage of using low filler fractions since the increase in viscosity can decrease the k_{eff} of NFs, as well as the flow characteristics of the fluids. It is also noted that the nature of enhancement in TC with filler fraction and temperature differs from fluid to fluid. Many factors such as fluid composition, viscosity, nature of fluids (morphology as well as interaction between fluid and nanofillers) can be the reasons for this difference. In this Example, Applicants have found that factors such as temperature and filler amount are more sensitive in determining the k_{eff} in low viscosity fluids.

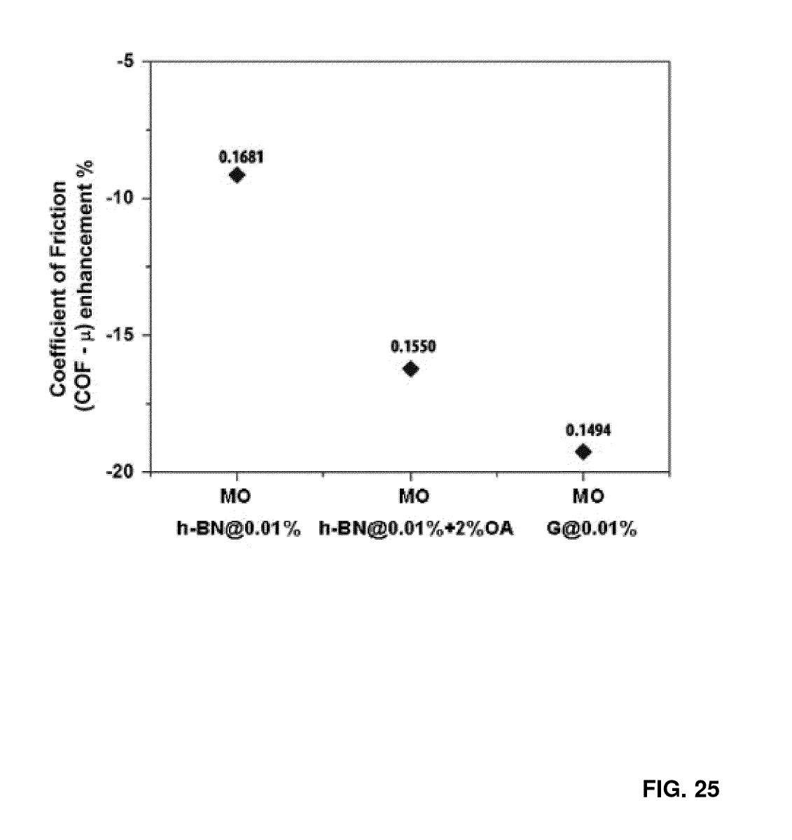

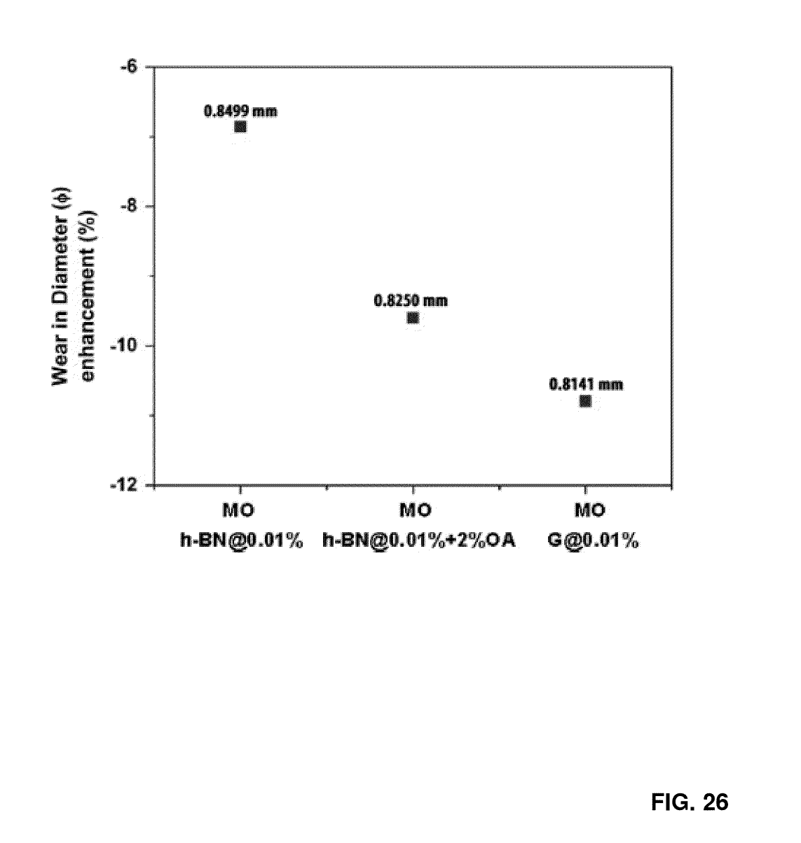

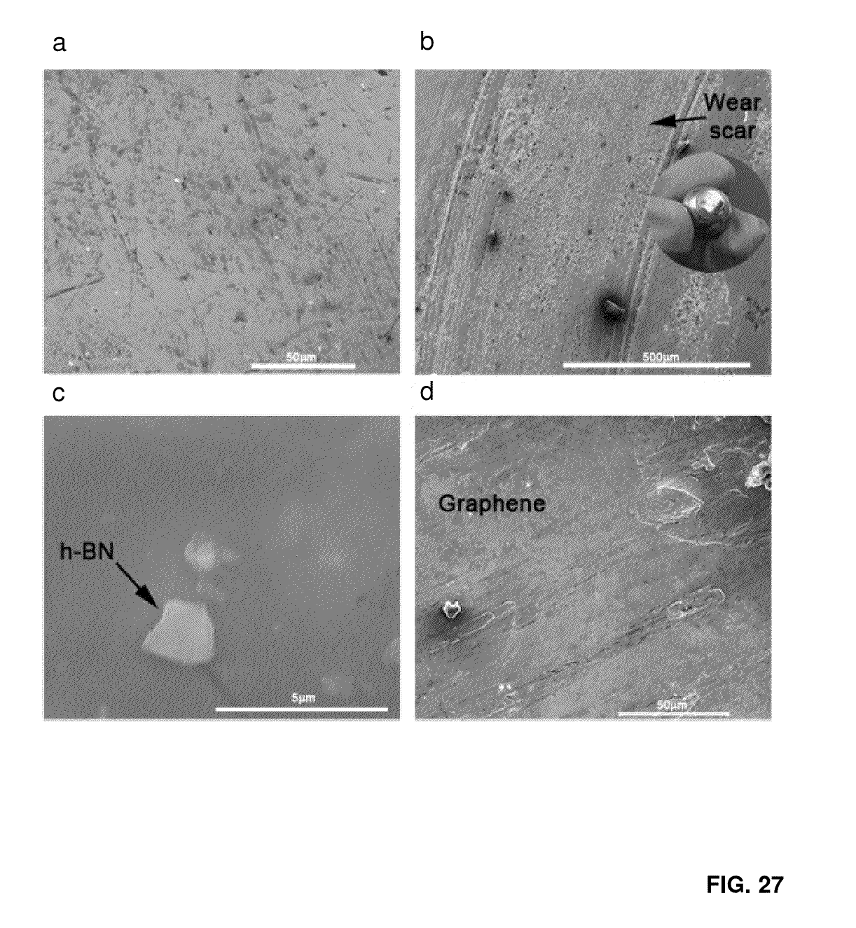

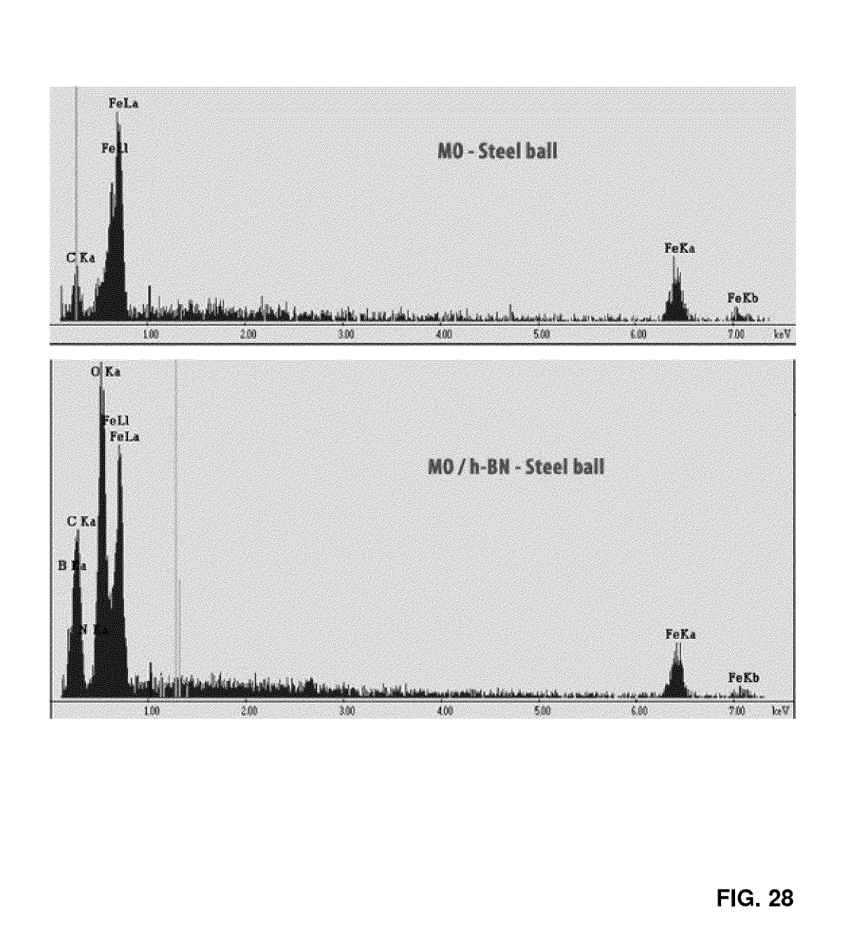

FIGS. 25-26 show the COF and steel balls' WSD tribo-testing results on mineral oil/h-BN (MO/h-BN) and mineral oil/graphene (MO/G) according to ASTM D5183 compared to bare MO, where those fluids were proven for their outstanding thermal performance in this Example. For MO/h-BN and MO/G with very low filler fractions (0.01 wt. %), a COF decrease was shown by 10% and 20%, respectively. The COF decrease from MO/G is attributed to the formation of graphene nano-bearings between the tester steel balls. In addition, the 2D-nanosheet morphology helps to promote an easy sliding mechanism to contribute to this effect.

Moreover, the aforementioned nanofillers were also utilized to stabilize MO with surfactant coating. Common surfactants such as oleic acid (OA) (2 vol. %) were added to the fluid with extensive sonication (˜4 h). OA-stabilized MO based fluids were also tested for their tribological properties. Bare MO with OA addition did not show significant enhancement in k_{eff} (<2% at 50° C.). Likewise, TC of OA-coated fluids does not show any change at the filler fraction of 0.01 wt. %. However, COF and WSD show a decrease compared to the surfactant-less material (˜6% more), indicating that OA may help to separate the nanoparticles and thereby decrease the agglomeration. Additional layering due to OA can increase the lubrication properties. Furthermore, it has been observed that agglomeration of nanofillers can adversely affect the lubrication properties of nanofillers.

For metal-cutting fluids, results obtained by the ITEePib Polish and ASTMD5183 methods were compared and analyzed in order to determine which lubricant performed better under different friction conditions. The main difference between these two methods is that the ITEePib Polish method tests lubricants under extreme pressure conditions for a short time, while the ASTM D5183 works under constant loads for a longer time.

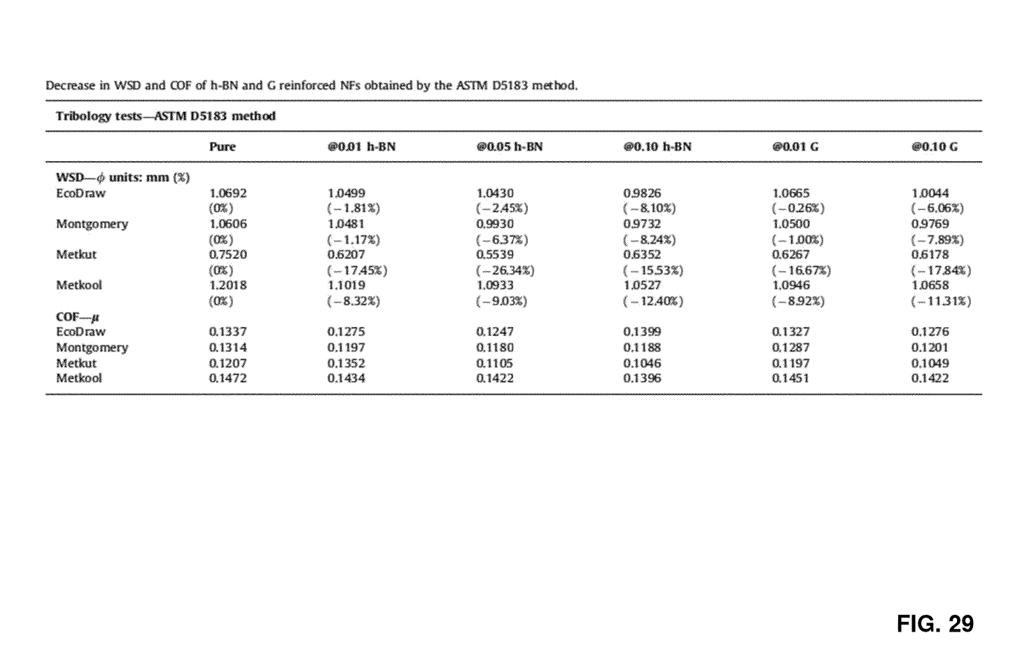

FIG. 29 shows the decrease on COF and steel balls WSD during tribo testings according to ASTM D5183, compared to bare fluids. The WSD was calculated from the average diameter of the three lower-balls (FIG. 14). At least 3 tests for each fluid (according to Dixon probabilistic methodology to generate statistical reliable results) were run. Lower COF and WSD values formed better fluids for tribological applications performance. In general, the addition of nanoparticles resulted in a significant decrease on these parameters. For instance, MO showed a decrease on COF and WSD up to 19.25% (μ=0.1494) and 10.79% (WSD=0.8141 mm), respectively, with the addition of 0.01 wt. % G (FIGS. 25-26). For metal-cutting NFs, the addition of h-BN and G showed similar improvement values on both COF and WSD, with Metkut NFs showing a major reduction of COF and WSD, possibly due to the oleophilic behavior of 2D nanosheets. Without being bound by theory, it is envisioned that the tribological mechanism for this test may be due to nanoparticles filling valleys and the shearing of trapped nanoparticles at the interface of contacting surfaces, thereby making NFs smooth and lowering the frictional forces.

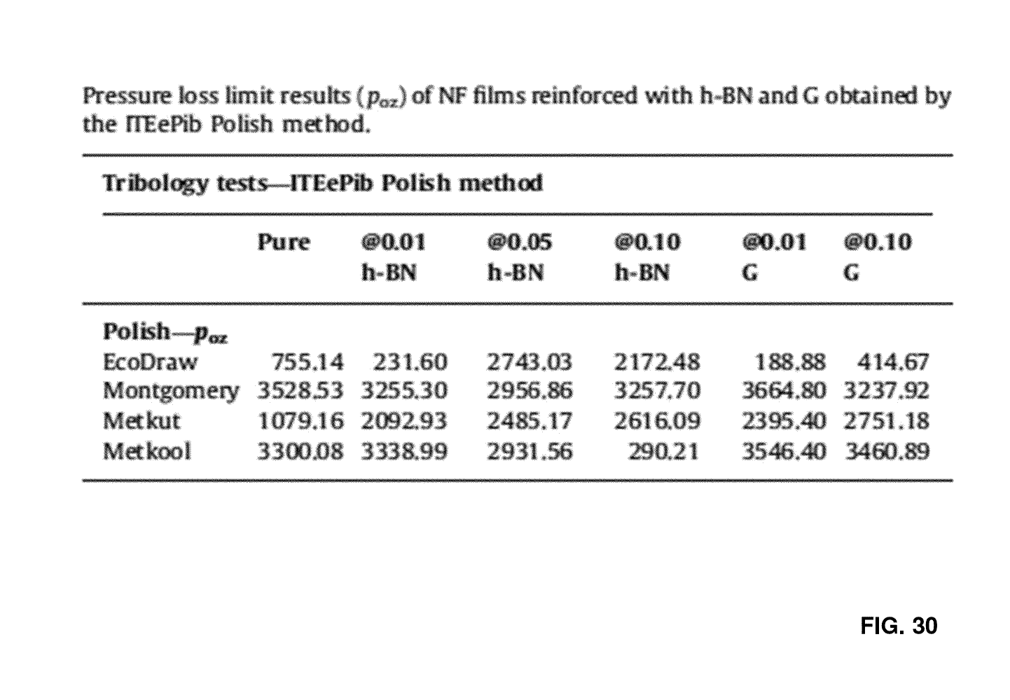

FIG. 30 presents a table of results obtained for lubricants and metal-cutting fluids, using the Polish method for calculating the extreme pressure (EP) properties of NFs, also known as the pressure loss limit of lubricant film. Here, the higher the p_{oz}, the better the lubricant, which works best under friction conditions. The COF is not included, since it is unusable due to the sudden increment of COF, particularly when the lubricant film disappears and high pressure occurs during the test. See FIG. 15. In contrast with the COF and WSD results obtained by the ASTMD5183 method, there was no apparent correlation between the p_{oz} and the type and concentration of nanofillers. Metkut (the highest viscosity base fluid) showed the highest improvement on p_{oz} with the addition of nanoparticles. The load carrying capacity increased up to 142.42% and 154.94% with 0.10% h-BN and 0.10% G, respectively. The results show that a small addition of nanoparticles may result in a considerable enhancement on the tribological behavior. Without being bound by theory, the tribological mechanism may consist of the tribo-sintering of nanoparticles into the surface due to the extreme pressure effect. For lower viscosity lubricants, however, the p_{oz} values are less consistent and in general showed either much smaller increments or an increase of COF and WSD. This can be explained as the lower viscosities result in a much rapid sedimentation and re-agglomeration of nanoparticles.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A fluid composition comprising:
a base fluid; and
boron nitride-based materials dispersed in the base fluid.

2. The fluid composition of claim 1, wherein the boron nitride-based materials are selected from the group consisting of boron nitride, exfoliated boron nitride, hexagonal boron nitride, cubic boron nitride, crystalline boron nitride, boron nitride sheets, boron nitride fibers, boron nitride nanotubes, boron nitride nanomesh, boron nitride nanoparticles, and combinations thereof.

3. The fluid composition of claim 1, wherein the boron nitride-based materials comprise hexagonal boron nitride.

4. The fluid composition of claim 3, wherein the hexagonal boron nitride is in the form of sheets.

5. The fluid composition of claim 4, wherein the hexagonal boron nitride sheets comprise from 2 atomic layers to 10 atomic layers.

6. The fluid composition of claim 4, wherein the hexagonal boron nitride sheets comprise from 2 atomic layers to 6 atomic layers.

7. The fluid composition of claim 4, wherein the hexagonal boron nitride sheets comprise from 4 atomic layers to 5 atomic layers.

8. The fluid composition of claim 4, wherein the hexagonal boron nitride sheets are anisotropic.

9. The fluid composition of claim 4, wherein the hexagonal boron nitride sheets are isotropic.

10. The fluid composition of claim 4, wherein the hexagonal boron nitride sheets have dimensions that range from about 10 nm to about 10 μm on each side.

11. The fluid composition of claim 4, wherein the hexagonal boron nitride sheets have dimensions that range from about 100 nm to about 500 nm on each side.

12. The fluid composition of claim 4, wherein the hexagonal boron nitride sheets have an aspect ratio of between about 1:1 and about 100:1.

13. The fluid composition of claim 1, wherein the boron nitride-based materials comprise less than about 5% of the weight of the fluid composition.

14. The fluid composition of claim 1, wherein the boron nitride-based materials comprise less than about 1% of the weight of the fluid composition.

15. The fluid composition of claim 1, wherein the boron nitride-based materials comprise from about 0.01% to about 0.1% of the weight of the fluid composition.

16. The fluid composition of claim 1, wherein the base fluid is selected from the group consisting of mineral oils, naphthenic oils, vegetable oils, synthetic oils, bio-based oils, natural and synthetic esters, crude oils, silicon fluids, silicate fluids, petroleum grease, silicone grease, water, brine, seawater, kerosene, ethylene glycols, aqueous fluids, non-aqueous fluids, oil-water emulsions, ionic liquids, clay-based fluids, thixotropic clay-based fluids, bentonite-based fluids, molten salt-based fluids, lubricants, metal-cutting fluids, and combinations thereof.

17. The fluid composition of claim 1, wherein the fluid composition has an enhanced thermal conductivity of about 5% to about 80% relative to the base fluid.

18. The fluid composition of claim 1, wherein the fluid composition has a reduced coefficient of friction of about 5% to about 30% relative to the base fluid.

19. The fluid composition of claim 1, wherein the fluid composition is substantially free of any dispersing agents.

20. The fluid composition of claim 1, wherein the fluid composition further comprises a dispersing agent.

21. The fluid composition of claim 20, wherein the dispersing agent comprises less than about 5.0% by weight of the fluid composition.

22. A method of making a fluid composition, wherein the method comprises dispersing boron nitride-based materials in a base fluid.

23. The method of claim 22, wherein the dispersing comprises mixing the boron nitride-based materials with the base fluid.

24. The method of claim 22, further comprising a step of exfoliating the boron nitride-based materials.

25. The method of claim 22, further comprising a step of sonicating the boron nitride-based materials.

26. The method of claim 22, wherein the boron nitride-based materials are selected from the group consisting of boron nitride, exfoliated boron nitride, hexagonal boron nitride, cubic boron nitride, crystalline boron nitride, boron nitride sheets, boron nitride fibers, boron nitride nanotubes, boron nitride nanomesh, boron nitride nanoparticles, and combinations thereof.

27. The method of claim 22, wherein the boron nitride-based materials comprise hexagonal boron nitride sheets.

28. The method of claim 27, wherein the hexagonal boron nitride sheets comprise from 2 atomic layers to 10 atomic layers.

29. The method of claim 22, wherein the boron nitride-based materials comprise less than about 1% of the weight of the fluid composition.

30. The method of claim 22, wherein the boron nitride-based materials comprise from about 0.01% to about 0.1% of the weight of the fluid composition.

31. The method of claim 22, wherein the base fluid is selected from the group consisting of mineral oils, naphthenic oils, vegetable oils, synthetic oils, bio-based oils, natural and synthetic esters, crude oils, silicon fluids, silicate fluids, petroleum grease, silicone grease, water, brine, seawater, kerosene, ethylene glycols, aqueous fluids, non-aqueous fluids, oil-water emulsions, ionic liquids, clay-based fluids, thixotropic clay-based fluids including bentonite-based fluids, molten salt-based fluids, lubricants, metal-cutting fluids, and combinations thereof.
